(19) United States
(12) Patent Application Publication
(10) Pub. No.: US 2011/0027478 A1
(43) Pub. Date: Feb. 3, 2011

(54) DOUBLE-SIDE COATING APPARATUS, METHOD FOR COATING DOUBLE SIDES WITH COATING SOLUTION, EDGE RINSING APPARATUS, AND EDGE RINSING METHOD

(75) Inventors: Masato Fukushima, Chiba-shi (JP); Tsubasa Okada, Ichihara-shi (JP); Hiroyuki Yamazaki, Ichihara-shi (JP); Naoyuki Imai, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/935,553

(22) PCT Filed: Mar. 30, 2009
(86) PCT No.: PCT/JP2009/056516

§ 371 Date: Sep. 29, 2010

(30) Foreign Application Priority Data
Mar. 31, 2008 (JP) 2008-090572
Mar. 31, 2008 (JP) 2008-090573
Mar. 31, 2008 (JP) 2008-090574
Mar. 31, 2008 (JP) 2008-090575

(51) Int. Cl. B05D 3/12; B05D 1/02; B05D 3/00; B08B 3/00

(52) U.S. Cl. 427/209; 134/32

(57) ABSTRACT

Provided is a double-side coating apparatus which can uniformly coat both surfaces of a substrate to be processed with a coating solution and form uniform coating films on both the surfaces of the substrate to be processed. A double-side coating apparatus (1) includes a holding mechanism (3a) which holds a substrate (2) to be processed so that the thickness direction of the substrate (2) to be processed is a horizontal direction; a rotational driving mechanism which rotates the substrate (2) to be processed in a circumferential direction; a first coating solution nozzle (18a) which jets a coating solution onto one main surface (2a) of the substrate (2) to be processed; and a second coating solution nozzle which jets the coating solution onto the other main surface (2b) of the substrate (2) to be processed. The first coating solution nozzle (18a) and the second coating solution nozzle are symmetrically arranged with respect to a thickness center surface of the substrate (2) to be processed. Provided is an edge rinsing apparatus which can accurately and stably rinse only a fixed width of an outer peripheral portion of the substrate and can easily control the width of the outer peripheral portion to be rinsed even if the width of the outer peripheral portion to be rinsed is small.

### TECHNICAL FIELD

The present invention relates to a double-side coating apparatus and a method for coating double sides with a coating solution, and specifically, to a double-side coating apparatus and a method for coating double sides with a coating solution, which coat a coating solution on both main surfaces of a substrate to be processed, and perform edge rinsing of the substrate to be processed on both the main surfaces of which the coating solution has been coated, and to a double-side coating apparatus and a method for coating double sides with a coating solution which can control the amount of coating with high precision with little variation in the amount of coating even if coating is performed on a plurality of substrates to be processed.

Additionally, the present invention relates to an edge rinsing apparatus and an edge rinsing method, and specifically, to an edge rinsing apparatus and an edge rinsing method which can accurately and stably rinse only outer edge portions of a substrate.

Priority is claimed on Japanese Patent Applications No. 2008-090572, 2008-090573, 2008-090574, and 2008-090575 filed on Mar. 31, 2008, the contents of which are incorporated herein by reference.

### BACKGROUND ART

A magnetic recording medium is used for magnetic recording devices, such as a magnetic disk device, a flexible disk device, and a magnetic tape device. In recent years, an attempt has been made to form irregularities along tracks on the surface of a magnetic recording medium and magnetically separate recording tracks from each other, thereby increasing track density. Such a magnetic recording medium is referred to as a discrete track medium.

In manufacturing the discrete track medium, there is a method of forming tracks after a magnetic recording medium is formed composed of several layers of thin films, or a method of forming thin films of a magnetic recording medium after an irregular pattern is formed directly on the surface of a substrate in advance or on a thin film layer for formation of tracks (for example, see Patent Documents 1 and 2). Among these methods, the former method is referred to as a magnetic layer processing type, and the latter method is referred to as an embossing type. In such methods of manufacturing a discrete track medium, lithography is often used, and a coating resist or photosensitive resin on a substrate may be required.

As an apparatus which performs coating on a substrate, an apparatus is known which can rotate a disk-shaped substrate in a circumferential direction while holding the substrate along a vertical plane, immerse the substrate in a liquid material with the rotating substrate being made vertical with respect to a coating container which stores the liquid material, pull up the substrate from the liquid material, and shake off any extra liquid material adhering to this substrate by the rotation of the substrate (refer to Patent Document 3).

Moreover, as a resist coating apparatus, an apparatus is known which can grip the outer peripheral portion of a disk-shaped wafer with a claw to rotatably hold the wafer within a horizontal plane, and coat a resist on both top and bottom surfaces of a rotating substrate in which nozzles are individually arranged above and below the substrate (refer to Patent Document 4).

Additionally, after the resist is coated onto the substrate, usually, the edge rinsing of removing any extra coating solution adhering to outer edges of the substrate is performed. When the resist is coated onto the substrate, a coating film with a large film thickness may be formed on the outer edges of the substrate due to the surface tension of the resist. By performing the edge rinsing to remove the portion with a large film thickness formed on the outer edges of the substrate, the homogeneity of the thickness of the coating film formed on the substrate can be improved, and the portion with a large film thickness can be prevented from hindering patterning of a resist layer.

The edge rinsing is performed by, for example, a method of blowing a rinsing solution against the peripheral edge of one surface of a substrate using an edge rinsing nozzle to remove any extra coating solution adhering to the one surface, and then blowing the rinsing solution against the peripheral edge of the other surface of the substrate using the edge rinsing nozzle to remove any extra coating solution adhering to the other surface.

[Patent Document 1] Japanese Patent Unexamined Publication No. 2004-178793

[Patent Document 2] Japanese Patent Unexamined Publication No. 2004-198794

[Patent Document 3] Japanese Patent Unexamined Publication No. 2004-306032

[Patent Document 4] Japanese Patent Unexamined Publication No. 7-245255

### DISCLOSURE OF INVENTION

However, in a case where a discrete track medium is manufactured using a method of manufacturing a magnetic layer processing type, physical machining of the surface of a medium is carried out after the medium is molded. Thus, there is a problem in that the medium is apt to be contaminated during physical machining, or a problem in that the manufacturing process becomes extremely complicated.

Additionally, in a case where a discrete track medium is manufactured using an embossing type manufacturing method, contamination during the manufacturing process hardly occurs. However, an irregular shape formed in a substrate carries over onto a film after the film is formed. Therefore, there is a problem in that the floating posture or floating height of a recording/reproducing head which performs recording/reproducing while being floated over a magnetic recording medium is not stabilized.

Hence, the present inventors repeated investigations in order to solve the above problems in the conventional method of manufacturing a discrete track medium. As a result, it was found that magnetic recording tracks can be magnetically separated by exposing regions other than the magnetic recording tracks and a servo signal pattern (magnetic recording pattern) to reactive plasma after a magnetic layer is formed. In such a method using reactive plasma, the magnetic layer is exposed to the reactive plasma after a resist is coated onto the entire surface of the magnetic layer to form a resist layer, and this resist layer is patterned so as to correspond to the magnetic recording pattern. Thereby, the magnetic properties of the region on the magnetic layer where the resist layer is not formed are reformed, and the magnetic recording tracks of the magnetic layer are magnetically separated from each other.

In the above method using reactive plasma, machining irregularities are not formed. Thus, a discrete track medium can be manufactured through a simple process, while avoiding contamination of the medium resulting from machining irregularities. Additionally, since the discrete track medium obtained by such a method does not have irregularities, a floating head can be made to float and travel stably.

Meanwhile, in the above method using reactive plasma, it is necessary to coat a resist on the entire surface of the magnetic layer and to form a resist layer. Additionally, for example, in a case where a magnetic recording medium (magnetic disk) to be used with the magnetic disk device is manufactured as the discrete track medium, it is necessary to form magnetic layers on both surfaces of a substrate. Therefore, it is necessary to coat resists on both the surfaces of the substrate to form resist layers on both the surfaces of the substrate.

However, in a case where resists are simultaneously coated onto both the surfaces of the substrate using the conventional coating apparatus, a problem occurs in that variation in the film thickness of the obtained resist layer is large.

The invention has been made in view of such circumstances, and the object thereof is to provide a double-side coating apparatus and a method for coating double sides with a coating solution which can uniformly coat both surfaces of a substrate to be processed with a coating solution and form uniform coating films on both the surfaces of the substrate to be processed.

In a case where resists are coated onto both the surfaces of the substrate using the conventional coating apparatus, and edge rinsing is performed, the variation in the drying state of a coating solution when the edge rinsing is performed is large on one surface and the other surface of the substrate. Therefore, a problem occurs in that poor rinsing resulting from the difference in the drying state is apt to occur.

The invention has been made in view of the above circumstances, and the object thereof is to provide a double-side coating apparatus and a method for coating double sides with a coating solution which can make constant the time taken until the edge rinsing is performed after the coating solution is coated onto both main surfaces of a substrate to be processed.

In the conventional coating apparatus, in a case where coating is performed on a plurality of substrates to be processed, a problem occurs in that the variation in the amount of coating is large, and the amount of coating cannot be controlled with high precision.

The invention has been made in view of the above circumstances, and the object thereof is to provide a double-side coating apparatus and a method for coating double sides with a coating solution, which have little variation in the amount of coating, and can control the amount of coating with high precision, even in a case where coating is performed on a plurality of substrates to be processed.

Additionally, in a case where resists are coated onto both surfaces of a substrate using the conventional coating apparatus, and edge rinsing is performed, only outer edges of the substrate which are portions to be edge-rinsed cannot be accurately and stably rinsed, and failures occur often in that the width of the outer edges to be rinsed become nonuniform, or a coating film remains on the outer edges of the substrate. Therefore, the yield was poor. In particular, in the conventional technique, in a case where the width of the outer edges to be rinsed is small, there is a case where only the outer edges to be rinsed cannot be rinsed with high precision.

The invention has been made in view of the above circumstances, and the object thereof is to provide an edge rinsing apparatus and an edge rinsing method which can accurately and stably rinse only a fixed width of an outer peripheral portion of the substrate and can easily control the width of the outer peripheral portion to be rinsed even if the width of the outer peripheral portion to be rinsed is small.

In order to solve the above problems, the present inventors have achieved the present invention as a result of having conducted diligent research.

(1) Provided is a double-side coating apparatus which supplies a coating solution to both main surfaces of a substrate to be processed, and rotationally operates the substrate to be processed to spread the coating solution to both the main surfaces, thereby forming the coating film on both the main surfaces of the substrate to be processed. The double-side coating apparatus includes: a holding mechanism which holds the substrate to be processed so that the thickness direction of the substrate to be processed is a horizontal direction; a rotational driving mechanism which rotates the substrate to be processed in a circumferential direction; a first coating solution nozzle which jets the coating solution onto one main surface of the substrate to be processed, and a second coating solution nozzle which jets the coating solution onto the other main surface of the substrate to be processed. The first coating solution nozzle and the second coating solution nozzle are symmetrically arranged with respect to a thickness center plane of the substrate to be processed.

(2) In the double-side coating apparatus according to the above (1), the first coating solution nozzle and the second coating solution nozzle jet the coating solution onto the inner peripheral portion and outer peripheral portion of the substrate to be processed.

Alternatively, the first coating solution nozzle and the second coating solution nozzle simultaneously jet the coating solution onto the inner peripheral portion and outer peripheral portion of the substrate to be processed.

(3) In the double-side coating apparatus according to the above (1) or (2), the amount of the coating solution jetted onto the inner peripheral portion by the first coating solution nozzle and the second coating solution nozzle becomes larger than the amount of the coating solution jetted onto the outer peripheral portion of the substrate to be processed by the first and second coating solution nozzles.

(4) In the double-side coating apparatus according to any one of the above (1) to (3), the first coating solution nozzle and/or the second coating solution nozzle have a plurality of coating solution jetting ports which is aligned from a position which faces the outer peripheral portion of the substrate to be processed toward a position which faces the inner peripheral portion.

(5) In the double-side coating apparatus according to any one of the above (1) to (3), the first coating solution nozzle and/or the second coating solution nozzle have coating solution jetting ports wherein the width of the jetting ports in the circumferential direction of the substrate to be processed becomes gradually larger from a position which faces the outer peripheral portion of the substrate to be processed toward a position which faces the inner peripheral portion.

(6) The double-side coating apparatus according to any one of the above (1) to (5) further includes a first coating solution nozzle moving mechanism which supports the first coating solution nozzle, and moves the first coating solution nozzle in the diameter direction of the substrate to be processed along the one main surface while being separated from the one main surface of the substrate to be processed, and a second coating solution nozzle moving mechanism which supports the second coating solution nozzle, and moves the second coating solution nozzle in the diameter direction of the substrate to be processed along the other main surface while being separated from the other main surface of the substrate to be processed.

(7) The double-side coating apparatus according to any one of the above (1) to (6) further includes an edge rinsing device which removes the coating solution adhering to outer edges of both the main surfaces of the substrate to be processed on which the coating solution has been coated. The edge rinsing device has a container in which a rinsing solution is stored, the liquid level of the rinsing solution is exposed through the top surface of the container, and the container is movably arranged at a position where the outer edges of the substrate to be processed which is rotating are immersed in the rinsing solution.

(8) In the double-side coating apparatus according to the above (7), a suction part which sucks droplets consisting of the rinsing solution is arranged adjacent to the edge rinsing device.

(9) In the double-side coating apparatus according to the above (8), the suction part is arranged at a side of the edge rinsing device wherein the side is the substrate-rotational direction side.

(10) The double-side coating apparatus according to any one of the above (1) to (6) further includes a head rinsing nozzle which jets a rinsing solution to clean the coating solution nozzle.

(11) In the double-side coating apparatus according to the above (10), the coating solution nozzle is composed of a first coating solution nozzle which jets a coating solution onto one main surface of the substrate to be processed; and a second coating solution nozzle which jets the coating solution onto the other main surface of the substrate to be processed, and the first coating solution nozzle and the second coating solution nozzle are symmetrically arranged with respect to a thickness center surface of the substrate to be processed. The head rinsing nozzle is composed of a first head rinsing solution nozzle provided adjacent to the first coating solution nozzle above the first coating solution nozzle, and a second head rinsing solution nozzle provided adjacent to the second coating solution nozzle above the second coating solution nozzle.

(12) The double-side coating apparatus according to the above (11) further includes a first coating solution nozzle moving mechanism which supports the first coating solution nozzle and the first head rinsing solution nozzle, and moves the first coating solution nozzle in the diameter direction of the substrate to be processed along the one main surface while being separated from the one main surface of the substrate to be processed, and a second coating solution nozzle moving mechanism which supports the second coating solution nozzle and the second head rinsing solution nozzle, and moves the second coating solution nozzle in the diameter direction of the substrate to be processed along the other main surface while being separated from the other main surface of the substrate to be processed.

(13) The double-side coating apparatus according to any one of the above (10) to (12) further includes a coating solution supply device which supplies the coating solution the coating solution nozzle, and a rinsing solution supply device which supplies the rinsing solution to the head rinsing nozzle. The coating solution supply device is provided with a coating solution piping which connects the coating solution nozzle with the coating solution tank, the rinsing solution supply device is provided with a rinsing solution piping which connects the head rinsing nozzle with the rinsing solution tank, the rinsing solution piping is connected with the coating solution piping by connection piping, and a switching valve is connected to the connection piping.

(14) Provided is an edge rinsing apparatus which removes a coating solution adhering to outer edges of both main surfaces of a substrate to be processed on which the coating solution has been coated. The edge rinsing apparatus includes: a holding mechanism which holds the substrate to be processed so that the thickness direction of the substrate to be processed is a horizontal direction, and a rotational driving mechanism which rotates the substrate to be processed in a circumferential direction; and a container in which a rinsing solution is stored. The liquid level of the rinsing solution is exposed through the top surface of the container, and the container is movably arranged at a position where the outer edges of the substrate to be processed which is rotating are immersed in the rinsing solution.

(15) The edge rinsing apparatus according to the above (14) further includes a container moving mechanism which supports the container, and moves the container in a horizontal direction and in a vertical direction.

(16) In the edge rinsing apparatus according to the above (14) or (15), a suction part which sucks droplets consisting of the rinsing solution is arranged adjacent to the container.

(17) In the edge rinsing apparatus according to the above (16), the suction part is arranged at a side of the container wherein the side is the substrate-rotational direction side.

(18) The edge rinsing apparatus according to the above (16) or (17) further includes a suction part moving mechanism which supports the suction part, and moves the suction part in a horizontal direction and in a vertical direction.

(19) Provided is a method for coating double sides with a coating solution which supplies a coating solution to both main surfaces of a substrate to be processed, and rotationally operates the substrate to be processed to spread the coating solution on both the main surfaces, thereby forming coating films on both the main surfaces of the substrate to be processed. The method includes a holding step of holding the substrate to be processed so that the thickness direction of the substrate to be processed is a horizontal direction, rotating the substrate to be processed in a circumferential direction, and simultaneously jetting the coating solution toward the substrate to be processed from a first coating solution nozzle which jets the coating solution onto one main surface of the substrate to be processed, and a second coating solution nozzle which is symmetrically arranged with respect to the first coating solution nozzle and a thickness center plane of the substrate to be processed, and jets the coating solution onto the other main surface of the substrate to be processed.

(20) In the method for coating double sides with a coating solution according to the above (19), the coating solution is jetted onto the inner peripheral portion and outer peripheral portion of the substrate to be processed from the first coating solution nozzle and the second coating solution nozzle.

(21) In the method for coating double sides with a coating solution according to the above (19) or (20), the amount of the coating solution jetted onto the inner peripheral portion from the first coating solution nozzle and the second coating solution nozzle is made larger than the amount of the coating solution jetted onto the outer peripheral portion of the substrate to be processed from the first and second coating solution nozzles.

(22) The method for coating double sides with a coating solution according to any one of the above (19) to (21) further includes an edge rinsing step of arranging a container, which stores a rinsing solution and has the liquid level of the rinsing solution exposed through the top surface thereof, at a position where the outer edge of the substrate to be processed which is being rotated after the coating step is immersed in the rinsing solution.

(23) In the method for coating double sides with a coating solution according to the above (22), the edge rinsing step is performed while droplets consisting of the rinsing solution are sucked by a suction part which is arranged adjacent to the container.

(24) The method for coating double sides with a coating solution according to any one of the above (19) to (21) further includes a coating solution nozzle cleaning step of jetting a rinsing solution from the head rinsing nozzle to clean the coating solution nozzle.

(25) Provided is a method for coating double sides with a coating solution which forms coating films on both main surfaces of a substrate to be processed, using the double-side coating apparatus according to the above (13). The method includes: a coating step of holding the substrate to be processed so that the thickness direction of the substrate to be processed is a horizontal direction, rotating the substrate to be processed in a circumferential direction, and jetting the coating solution from a coating solution nozzle which jets the coating solution onto both the main surfaces of the substrate to be processed toward the substrate to be processed; and a coating solution piping cleaning step of switching the switching valve to clean the coating solution piping closer to the coating solution nozzle than the switching valve, and the coating solution nozzle.

(26) Provided is an edge rinsing method which removes a coating solution adhering to outer edges of both main surfaces of a substrate to be processed on which the coating solution has been coated. The edge rinsing method includes: an edge rinsing step of holding the substrate to be processed so that the thickness direction of the substrate to be processed is a horizontal direction, thereby rotating the substrate to be processed in a circumferential direction, and rinsing a container which stores a rinsing solution, and has the liquid level of the rinsing solution exposed through the top surface of the container, at a position where the outer edges of the substrate to be processed which is rotating are immersed in the rinsing solution.

(27) The edge rinsing method according to the above (26) further includes an attaching/detaching step which attaches and detaches the substrate to be processed to/from a holding mechanism which holds the substrate to be processed, and the attaching/detaching step is performed by moving the container in a horizontal direction and in a vertical direction by a container moving mechanism which supports the container, thereby retreating the container.

(28) In the edge rinsing method according to the above (26) or (27), the edge rinsing step is performed while droplets consisting of the rinsing solution are sucked by a suction part which is arranged adjacent to the container.

The double-side coating apparatus of the invention includes a holding mechanism which holds a substrate to be processed so that the thickness direction of the substrate to be processed is a horizontal direction; a rotational driving mechanism which rotates the substrate to be processed in a circumferential direction; a first coating solution nozzle which jets a coating solution onto one main surface of the substrate to be processed; and a second coating solution nozzle which jets the coating solution onto the other main surface of the substrate to be processed. The first coating solution nozzle and the second coating solution nozzle are symmetrically arranged with respect to a thickness center surface of the substrate to be processed. Thus, a coating solution is simultaneously supplied to the same position in both the main surfaces of the substrate to be processed, by jetting the coating solution simultaneously toward the substrate to be processed from the first coating solution nozzle and the second coating solution nozzle. Therefore, according to the double-side coating apparatus of the invention, as there is no difference resulting from gravity in coating onto one main surface of the substrate to be processed, and coating onto the other main surface, or difference resulting from the coating positions, the coating solution can be uniformly coated onto both the surfaces of the substrate to be processed, and uniform coating films can be formed on both the surfaces of the substrate to be processed.

Additionally, according to the double-side coating apparatus of the invention, a first coating solution nozzle which jets a coating solution onto one main surface of the substrate to be processed, and a second coating solution nozzle which jets the coating solution onto the other main surface of the substrate to be processed are included. Thus, by controlling the amount of a coating solution jetted from the first coating solution nozzle and the second coating solution nozzle, and the number of times of jetting, the control of the amount of coating can be easily performed whether or not the amount of coating is small or large.

On the other hand, for example, in a case where nozzles are individually arranged above and below a substrate, and a resist is coated onto both top and bottom surfaces of the substrate which is being rotated, the difference resulting from gravity in coating onto the top surface of the substrate and coating onto the bottom surface is caused. Therefore, the control of the amount of coating onto the top and bottom surfaces of the substrate was difficult. Additionally, in a case where the substrate is held along a vertical plane, and the substrate is immersed in a liquid material with the rotating substrate being made vertical with respect to a coating container which stores the liquid material, there is no difference resulting from gravity in coating onto one main surface of the substrate to be processed and coating onto the other main surface. However, since the substrate is coated by immersing the substrate in the liquid material, the control of the amount of coating is difficult.

Additionally, according to the double-side coating apparatus of the invention, a first coating solution nozzle which jets a coating solution onto one main surface of the substrate to be processed, and a second coating solution nozzle which jets the coating solution onto the other main surface of the substrate to be processed are included. Thus, by moving the first coating solution nozzle, and the second coating solution nozzle, the coating position to both the main surfaces of the substrate to be processed can be easily changed. Accordingly, in the double-side coating apparatus of the invention, for example, in order to control the thickness or the like of a coating film to be formed on the substrate to be processed, the coating position to both the main surfaces of the substrate to be processed can be changed.

Additionally, according to the double-side coating apparatus of the invention, it is possible to simultaneously supply a coating solution to both the main surfaces of the substrate to be processed. Thus, by simultaneously supplying the coating solution to both the main surfaces of the substrate to be processed, the coating solution can be easily coated onto both the main surfaces of the substrate to be processed in a short time, as compared to the case where the coating solution is supplied to the other main surface after the coating solution is supplied to one main surface of the substrate to be processed.

Additionally, according to the method for coating double sides with the coating solution of the invention, the substrate to be processed is held so that the thickness direction of the substrate to be processed is a horizontal direction, the substrate to be processed is rotated in a circumferential direction, and the coating solution is simultaneously jetted toward the substrate to be processed from a first coating solution nozzle which jets the coating solution onto one main surface of the substrate to be processed, and a second coating solution nozzle which is symmetrically arranged with respect to the first coating solution nozzle and a thickness center plane of the substrate to be processed, and jets the coating solution onto the other main surface of the substrate to be processed. Thus, the coating solution can be simultaneously supplied to the same position on both the main surfaces of the substrate to be processed, the coating solution can be uniformly coated onto both the surfaces of the substrate to be processed, and uniform coating films can be formed on both the surfaces of the substrate to be processed.

The double-side coating apparatus of the invention includes a holding mechanism which holds the substrate to be processed so that the thickness direction of the substrate to be processed is a horizontal direction, a rotational driving mechanism which rotates the substrate to be processed in a circumferential direction, a coating solution nozzle which simultaneously jets the coating solution onto both the main surfaces of the substrate to be processed, and an edge rinsing device which removes the coating solution adhering to outer edges of both the main surfaces of the substrate to be processed on which the coating solution has been coated. The liquid level of the rinsing solution is exposed through the top surface of the container, and the container is movably arranged at a position where the outer edges of the substrate to be processed which is rotating are immersed in the rinsing solution. Thus, after the coating solution is simultaneously coated onto both the main surfaces of the substrate to be processed, edge rinsing can be simultaneously performed on both the main surfaces of the substrate to be processed. Accordingly, in the double-side coating apparatus of the invention, the time taken until the edge rinsing is performed after the coating solution is coated becomes constant in both the main surfaces of the substrate to be processed. Hence, poor rinsing resulting from the difference in a drying state, such that the drying state of the coating solution when the edge rinsing is started becomes the same on both the surfaces, and drying becomes excessive and the edge rinsing becomes difficult, hardly occurs, and the edge rinsing can be stably performed.

Additionally, the double-side coating apparatus of the invention can perform coating and edge rinsing on both the main surfaces of the substrate to be processed, and utilizes the holding mechanism and the rotational driving mechanism not only during the coating but also during the edge rinsing. For this reason, in the double-side coating apparatus of the invention, for example, the space for performing the coating and the edge rinsing can be made small as compared to the case where the coating and the edge rinsing are performed using the coating apparatus including the holding mechanism and the rotational driving mechanism, and the edge rinsing apparatus including the holding mechanism and the rotational driving mechanism.

Additionally, in the double-side coating apparatus of this embodiment, the edge rinsing is simultaneously performed on both the main surfaces of the substrate to be processed after a coating solution is simultaneously coated onto both the main surfaces of the substrate to be processed. Thus, the coating and the edge rinsing can be efficiently performed in a short time compared to the case where the coating and/or the edge rinsing are performed on every one surface of the substrate to be processed.

Additionally, the method for coating double sides with a coating solution includes a coating step of holding the substrate to be processed so that the thickness direction of the substrate to be processed is a horizontal direction, rotating the substrate to be processed in a circumferential direction, and simultaneously jetting the coating solution toward the substrate to be processed from a coating solution nozzle which simultaneously jets the coating solution onto both the main surfaces of the substrate to be processed, and an edge rinsing step of arranging a container, which stores a rinsing solution and has the liquid level of the rinsing solution exposed through the top surface thereof, at a position where the outer edge of the substrate to be processed which is being rotated after the coating step is immersed in the rinsing solution. Thus, after the coating solution is simultaneously coated onto both the main surfaces of the substrate to be processed, edge rinsing can be simultaneously performed on both the main surfaces of the substrate to be processed.

The double-side coating apparatus of the invention includes a holding mechanism which holds the substrate to be processed so that the thickness direction of the substrate to be processed is a horizontal direction, a rotational driving mechanism which rotates the substrate to be processed in a circumferential direction, a coating solution nozzle which simultaneously jets the coating solution onto both the main surfaces of the substrate to be processed, and a head rinsing nozzle which jets a rinsing solution to clean the coating solution nozzle. Thus, the coating solution nozzle can be cleaned by jetting the rinsing solution from the head rinsing nozzle after the coating solution is jetted from the coating solution nozzle toward the substrate to be processed. Accordingly, in the double-side coating apparatus of the invention, the coating solution nozzle can be prevented from being clogged, variation in the amount of jetting, which is caused when a coating solution or a coating film adheres to the coating solution nozzle, can be prevented, and even in a case where coating is performed on a plurality of substrates to be processed, there is little variation in the amount of coating, and the amount of coating can be controlled with high precision. Additionally, according to the double-side coating apparatus of the invention, the coating solution can be jetted onto both the main surfaces of the substrate to be processed from the coating solution nozzle by rotating the substrate to be processed in the circumferential direction. Thus, by controlling the amount of a coating solution jetted from the coating solution nozzle, and the number of times of jetting, the control of the amount of coating can be easily performed even if the amount of coating is small or large.

On the other hand, for example, in a case where nozzles are individually arranged above and below a substrate, and a resist is coated onto both top and bottom surfaces of the substrate which is being rotated, the amount of jetting varies since the nozzles are clogged, or a coating solution or a coating film adhere to the nozzles. Thus, it was difficult to control the amount of jetting with high precision in a case where coating was performed on a plurality of substrates to be processed. Particularly, since the resist is apt to adhere to the nozzles arranged below the substrate, variation in the amount of coating in the bottom surface of the substrate was large. Additionally, in a case where nozzles are individually arranged above and below a substrate, and a resist is coated onto both top and bottom surfaces of the substrate which is being rotated, the difference resulting from gravity in coating onto the top surface of the substrate and coating onto the bottom surface is caused. Therefore, the control of the amount of coating onto the top and bottom surfaces of the substrate was difficult.

Additionally, in a case where the substrate is held along a vertical plane, and the substrate is immersed in a liquid material with the rotating substrate being made vertical with respect to a coating container which stores the liquid material, there is no difference resulting from gravity in coating onto one main surface of the substrate to be processed and coating onto the other main surface, and there is no variation in the amount of jetting which is caused when a coating solution or a coating film adheres to the nozzles or the nozzles are clogged. However, since the substrate was coated by immersing the substrate in the liquid material, the control of the amount of coating was difficult.

Additionally, the method for coating double sides with a coating solution of the invention includes a coating step of holding the substrate to be processed so that the thickness direction of the substrate to be processed is a horizontal direction, rotating the substrate to be processed in a circumferential direction, and jetting the coating solution from a coating solution nozzle which jets the coating solution onto both the main surfaces of the substrate to be processed toward the substrate to be processed; and a coating solution nozzle cleaning step of jetting a rinsing solution from a head rinsing nozzle to clean the coating solution nozzle. Thus, the coating solution nozzle can be prevented from being clogged, variation in the amount of jetting, which is caused when a coating solution or a coating film adheres to the coating solution nozzle, can be prevented, and even in a case where coating is performed on a plurality of substrates to be processed, there is little variation in the amount of coating, and the amount of coating can be controlled with high precision.

The edge rinsing apparatus of the invention includes a holding mechanism which holds a substrate to be processed so that the thickness direction of the substrate to be processed is a horizontal direction, a rotational driving mechanism which rotates the substrate to be processed in a circumferential direction, and a container which stores a rinsing solution. The liquid level of the rinsing solution is exposed through the top surface of the container, and the container is arranged at a position where the outer edge of the substrate to be processed which is being rotated is immersed in the rinsing solution. By setting the width of the outer edge of the substrate to be processed, which is immersed in the rinsing solution, to a predetermined width, only a region with a fixed width of the outer edge of the substrate to be processed can be accurately and stably rinsed.

Additionally, in the edge rinsing apparatus of the invention, the width of the outer edge to be rinsed does not vary depending on the jetting amount or jetting position of a rinsing solution to be jetted from the nozzle. As compared to the case where the edge rinsing nozzle is provided, the width of the outer edge to be rinsed can be easily controlled. Even if the width of the outer edge to be rinsed is small, there is no occurrence of failure such that the width of the outer edge to be rinsed is uneven, or a coating film remains on the outer edge of the substrate. Thus, the yield can be improved.

Additionally, according to the edge rinsing apparatus of the invention, it is possible to simultaneously perform the edge rinsing on both the main surfaces of the substrate to be processed. Thus, the edge rinsing can be easily performed on both the main surfaces of the substrate to be processed in a short time as compared to a case where a rinsing solution is blown against the peripheral edge of one surface of a substrate using the edge rinsing nozzle to remove any extra coating solution adhering to the one surface, and the rinsing solution is blown against the peripheral edge of the other surface of the substrate using the edge rinsing nozzle to remove any extra coating solution adhering to the other surface.

Additionally, the edge rinsing method of the invention has an edge rinsing step of holding the substrate to be processed so that the thickness direction of the substrate to be processed is a horizontal direction, thereby rotating the substrate to be processed in a circumferential direction; and arranging a container which stores a rinsing solution, and has the liquid level of the rinsing solution exposed through the top surface of the container, at a position where the outer edges of the substrate to be processed which is rotating are immersed in the rinsing solution. Thus, by setting the width of the outer edge of the substrate to be processed, which is immersed in the rinsing solution, to a predetermined width, only a region with a fixed width, of the outer edge of the substrate to be processed can be accurately and stably rinsed.

### BRIEF DESCRIPTION OF THE DRAWINGS

FIG. 1 is a sectional view showing an example of a discrete magnetic recording medium.

FIG. 2 is a schematic diagram for explaining the overall configuration of a double-side coating apparatus of the invention, and is a front view seen from one main surface of a substrate to be processed.

FIG. 3 is a longitudinal sectional view showing a portion of the double-side coating apparatus shown in FIG. 2.

FIG. 4 is a top view showing a portion of the double-side coating apparatus shown in FIG. 2.

FIG. 5A is a view for explaining the shape of a coating solution jetting port of a first coating solution nozzle 18a and/or a second coating solution nozzle 18b.

FIG. 5B is a view for explaining the shape of the coating solution jetting port of the first coating solution nozzle 18a and/or the second coating solution nozzle 18b.

FIG. 6 is a schematic enlarged view for explaining an arrangement of the first coating solution nozzle 18a and the second coating solution nozzle 18b, and a substrate 2 to be processed.

FIG. 7 is a process drawing for explaining the process of manufacturing the discrete magnetic recording medium shown in FIG. 1.

FIG. 8 is a process drawing for explaining the process of manufacturing the discrete magnetic recording medium shown in FIG. 1.

FIG. 9 is a process drawing for explaining the process of manufacturing the discrete magnetic recording medium shown in FIG. 1.

FIG. 10A is a view for explaining the operation of the double-side coating apparatus 1 shown in FIG. 2, and is a front view seen from one main surface 2a of the substrate 2 to be processed.

FIG. 10B is a view for explaining the operation of the double-side coating apparatus 1 shown in FIG. 2, and is a front view seen from one main surface 2a of the substrate 2 to be processed.

FIG. 11 is a plan view of a resist coating film of an example.

FIG. 12 is a plan view of a resist coating film of a comparative example.

### EXPLANATION OF REFERENCE

1: DOUBLE-SIDE COATING APPARATUS
2: SUBSTRATE TO BE PROCESSED
2a: ONE MAIN SURFACE
2b: OTHER MAIN SURFACE
3a: HOLDING MECHANISM
3: ROTATIONAL DRIVING MECHANISM
6: SUBSTRATE-TO-BE PROCESSED HOUSING PORTION
6a: MAIN BODY
6b: HEAD RINSING PORTION
8: SPINDLE MOTOR
11: CHUCKING PORTION
12: ROTARY SHAFT
9: SPINDLE SHAFT
10: PULLEY
16a, 16b: ATTACHMENT PORTION
17a: FIRST COATING SOLUTION NOZZLE MOVING MECHANISM
17b: SECOND COATING SOLUTION NOZZLE MOVING MECHANISM
18a: FIRST COATING SOLUTION NOZZLE
18b: SECOND COATING SOLUTION NOZZLE
19a: FIRST HEAD RINSING SOLUTION NOZZLE
19b: SECOND HEAD RINSING SOLUTION NOZZLE
20: COATING SOLUTION SUPPLY DEVICE
20a: COATING SOLUTION TANK
20b: COATING SOLUTION PIPING
20c: COATING SOLUTION VALVE
21: RINSING SOLUTION SUPPLY DEVICE
21a: RINSING SOLUTION TANK
21b: RINSING SOLUTION PIPING
21c: RINSING SOLUTION VALVE
21d: BRANCH PIPING
21e: RINSING SOLUTION VALVE
22: INNER PERIPHERAL PORTION
23: OUTER PERIPHERAL PORTION
25: LIQUID DISCHARGE DEVICE
25a: WASTE LIQUID TANK
25b: LIQUID DISCHARGE PIPING
25c: BRANCH LIQUID DISCHARGE PIPING
25d: WASTE LIQUID TANK
25e: LIQUID DISCHARGE PIPING
25f: LIQUID DISCHARGE VALVE
25g: LIQUID DISCHARGE DEVICE
26: GAS DISCHARGE DEVICE
26a: EXHAUST GAS TANK
26b: PIPING
27: GAS SUPPLY DEVICE
31, 32, 33, 34, 35: COATING SOLUTION JETTING PORT
40: EDGE RINSING DEVICE
41: CONTAINER
41a: OPENING
42: CONTAINER MOVING MECHANISM
43: SUCTION DEVICE
43a: SUCTION PART
43b: SLIT
43c: INNER WALL SURFACE
43d: OUTER WALL
44: SUCTION PART MOVING MECHANISM
100: MAGNETIC RECORDING MEDIUM
101: NONMAGNETIC SUBSTRATE
101a: CENTRAL OPENING
102: FOUNDATION LAYER
103: MAGNETIC LAYER
104: REFORMING PORTION
105: PROTECTIVE FILM

### BEST MODE FOR CARRYING OUT THE INVENTION

Next, a double-side coating apparatus and a method for coating double sides with a coating solution of the invention, and an edge rinsing apparatus and an edge rinsing method of the invention will be described in detail, referring to the drawings.

<Discrete Magnetic Recording Medium>

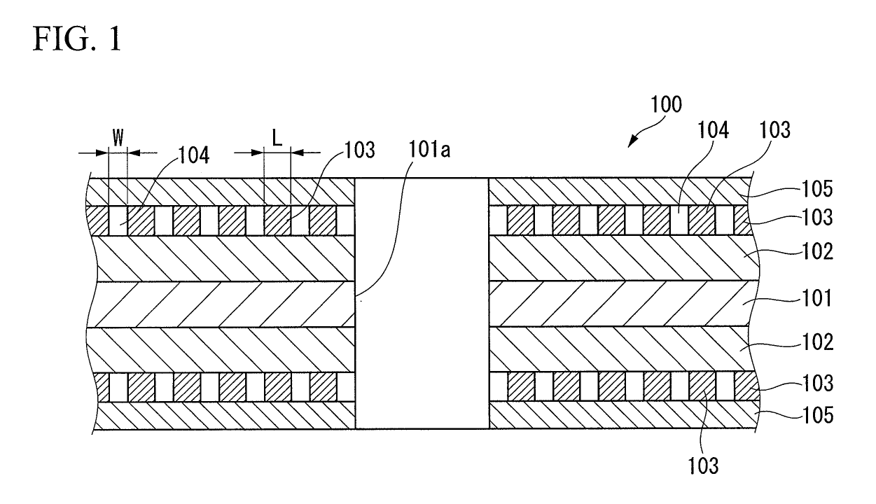

First, an example of a discrete magnetic recording medium will be described as an example of a substrate to be processed on which a coating film is formed using the double-side coating apparatus of the invention. FIG. 1 is a sectional view showing an example of the discrete magnetic recording medium.

A magnetic recording medium 100 shown in FIG. 1 is one in which a foundation layer 102 with a multiple layer structure including a soft magnetic layer, an intermediate layer, and the like, a magnetic layer 103, a reforming portion 104, and a protective film 105 are formed in both main surfaces (a top surface and a bottom surface), respectively, of a nonmagnetic substrate 101 which have a central opening 101a, and the outermost surface thereof is formed with a lubricating film (not shown).

In addition, in FIG. 1, the thicknesses of the foundation layer 102, the magnetic layer 103 having a magnetic pattern, the reforming portion 104, and the protective film 105 are largely shown in an exaggerated manner, respectively, with respect to the thickness of the nonmagnetic substrate 101. However, the actual thickness of the nonmagnetic substrate 101 is far thicker than these layers and films. In order to make these layers and films easily seen in FIG. 1, the layers and films are shown in an exaggerated manner.

As the nonmagnetic substrate 101, arbitrary substrates can be used if they are Al alloy substrates made of, for example, Al—Mg alloy and the like, which are composed mainly of aluminum, or nonmagnetic substrates, such as substrates made of normal soda glass, aluminosilicate-based glass, crystallized glass, silicon, titanium, ceramics, and various resins.

The magnetic layer 103 is a magnetic recording pattern equivalent to a magnetic recording track and servo signal pattern portion. Although an in-plane magnetic recording layer or a perpendicular magnetic recording layer is sufficient as the magnetic layer 103, the perpendicular magnetic recording layer is preferable in order to realize higher recording density. It is preferable that the magnetic recording layer 103 be formed from alloys composed mainly of Co.

For example, a laminated structure composed of a nonmagnetic CrMo foundation layer and a ferromagnetic CoCrPtTa magnetic layer can be utilized as the magnetic recording layer for a planar magnetic recording medium.

As the magnetic recording layer for a perpendicular magnetic recording medium, a magnetic recording layer can be utilized which is obtained by laminating a backing layer made of, for example, soft magnetic FeCo alloys (FeCoB, FeCoSiB, FeCoZr, FeCoZrB, FeCoZrBCu, or the like), FeTa alloys (FeTaN, FeTaC, or the like), Co alloys (CoTaZr, CoZrNB, CoB, or the like), or the like, an orientation control film made of Pt, Pd, NiCr, NiFeCr, or the like, and the interlayer made of Ru, or the like if necessary, and a magnetic layer made of a 60Co-15Cr-15Pt alloy or a 70Co-5Cr-15Pt-10SiO₂ alloy.

The thickness of the magnetic recording layer is set to, for example, 3 nm or more and 20 nm or less, and to, preferably, 5 nm or more and 15 nm or less.

Additionally, as shown in FIG. 1, a region where the magnetic layer 103 is not formed is formed with the reforming portion 104 which is a nonmagnetic portion where the magnetic properties of the magnetic layer 103 are reformed. The magnetic recording pattern which constitutes the magnetic layer 103 is magnetically separated by the reforming portion 104 to prevent the signal interference between magnetic recording patterns of adjacent magnetic layers 103.

The reforming of the magnetic properties of the magnetic layer 103 specifically means partially changing the coercive force, residual magnetization, or the like of a magnetic layer formed as a uniform film on the nonmagnetic substrate 101, and means lowering the coercive force, or lowering the residual magnetization, as an example of the change.

The reforming of the magnetic properties can be carried out, for example, by exposing regions other than a region serving as the magnetic recording pattern of the magnetic layer formed as a uniform film on the nonmagnetic substrate 101, to reactive plasma, and the portion exposed to the reactive plasma becomes the reforming portion 104.

Additionally, as the protective film 105, carbonaceous layers made of carbon (C), hydrogenated carbon (H_{X}C), nitrogenated carbon (CN), amorphous carbon, or silicon carbide (SiC), or protective film materials, which are usually used, such as SiO₂, Zr₂O₃, TiN, or the like can be used. Additionally, the protective film 105 may be composed of two or more layers.

It is preferable to appropriately form the lubricating layer on the protective film 105. The lubricant used for the lubrication layer includes fluorine-based lubricant, hydrocarbon-based lubricant, mixtures thereof, and the like.

In the magnetic recording medium 100 shown in FIG. 1, the magnetic recording pattern is magnetically and reliably separated as the magnetic properties of regions other than the magnetic recording pattern of the magnetic layer 103 are reformed, and the regions are formed as the reforming portion 104. Thus, excellent high recording density characteristics can be obtained without being influenced by the signal interference between adjacent patterns.

<Double-Side Coating Apparatus>

Next, one embodiment of the double-side coating apparatus of the invention will be described.

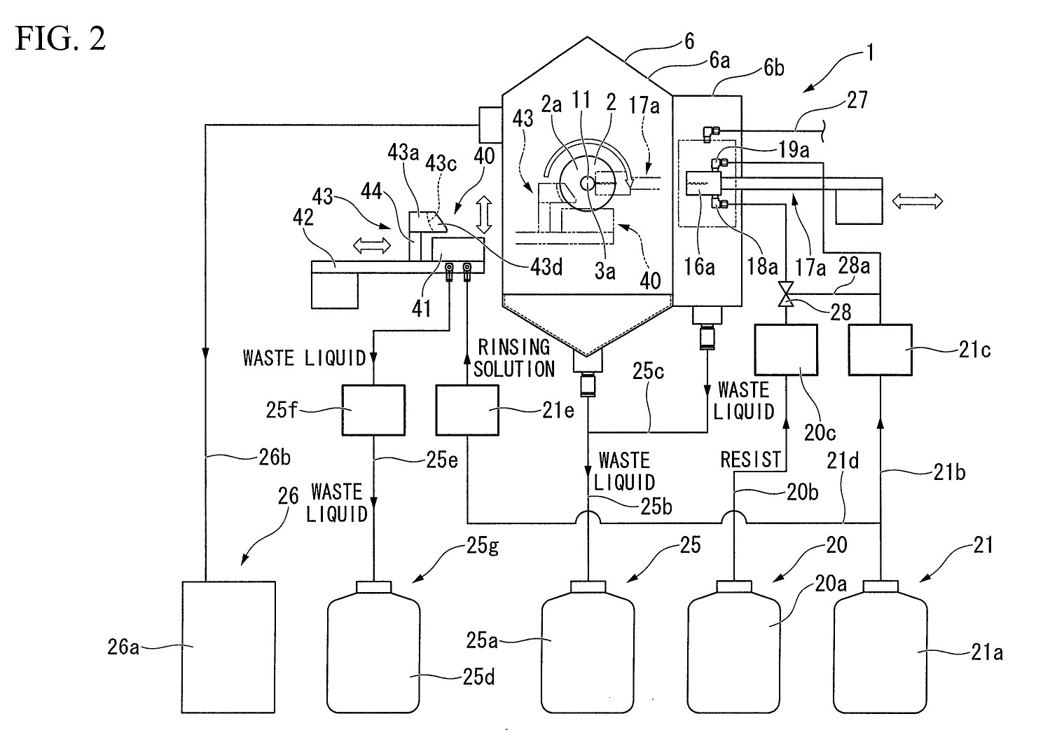

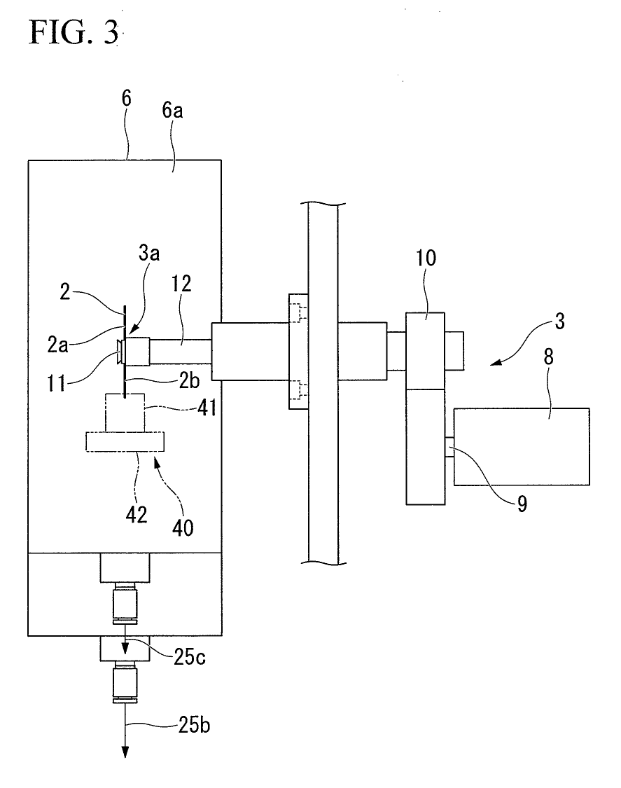

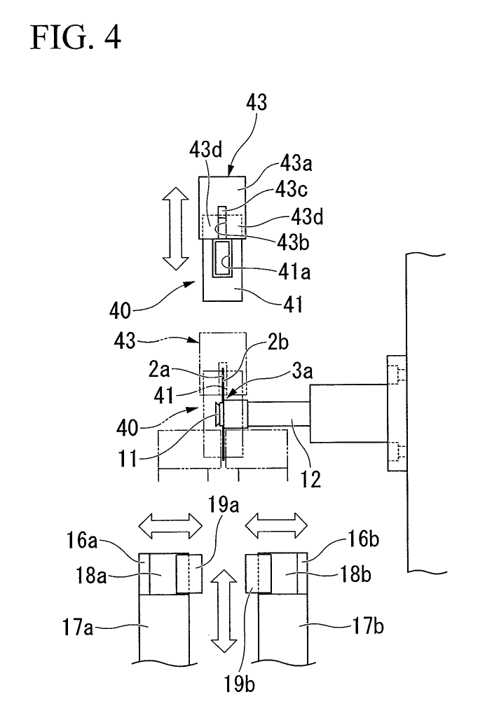

FIG. 2 is a schematic diagram for explaining the overall configuration of the double-side coating apparatus of the invention, and is a front view seen from one main surface of a substrate to be processed. Additionally, FIG. 3 is a longitudinal sectional view showing a portion of the double-side coating apparatus shown in FIG. 2, and FIG. 4 is a top view showing a portion of the double-side coating apparatus shown in FIG. 2.

A double-side coating apparatus 1 shown in FIGS. 2 to 4 supplies a coating solution to one main surface 2a and other main surface 2b of a doughnut disk-shaped substrate 2 to be processed, and rotationally operates the substrate 2 to be processed to spread the coating solution on one main surface 2a and other main surface 2b, thereby forming coating films on the one main surface 2a and other main surface 2b of the substrate 2 to be processed.

As shown in FIGS. 2 to 4, the double-side coating apparatus 1 includes a holding mechanism 3a, a rotational driving mechanism 3, a first coating solution nozzle moving mechanism 17a, a second coating solution nozzle moving mechanism 17b, a first coating solution nozzle 18a, a second coating solution nozzle 18b, an edge rinsing device 40, a suction device 43, and a substrate-to-be processed housing portion 6.

The substrate-to-be processed housing portion 6 has a main body 6a and a head rinsing portion 6b. As shown in FIG. 2, the substrate 2 to be processed which is held by the holding mechanism 3a is housed at a central portion of the main body 6a within the substrate-to-be processed housing portion 6, and one main surface 2a of the substrate 2 to be processed is rotated clockwise by the rotational driving mechanism 3. Additionally, the head rinsing portion 6b is provided in the 3 o'clock direction with respect to the center of the substrate 2 to be processed, and is joined to the main body 6a.

Additionally, as shown in FIG. 2, the substrate-to-be processed housing portion 6 is provided with a gas supply device 27 which supplies purge gas from the head rinsing portion 6b of the substrate-to-be processed housing portion 6, and a gas discharge device 26 for discharging gas from the main body 6a of the substrate-to-be processed housing portion 6. As the purge gas, for example, dry air, nitrogen, hydrogen, carbon dioxide, helium, neon, argon, krypton, xenon, and the like are used.

The gas discharge device 26 includes an exhaust gas tank 26a, and piping 26b which connects the main body 6a with the exhaust gas tank 26a. Additionally, the substrate-to-be processed housing portion 6 is provided with a liquid discharge device 25 for discharging a waste liquid from the head rinsing portion 6b and the main body 6a of the substrate-to-be processed housing portion 6, respectively. The liquid discharge device 25 includes a waste liquid tank 25a, liquid discharge piping 25b which connects the waste liquid tank 25a with the main body 6a, and branch liquid discharge piping 25c which branches from the liquid discharge piping 25b and is connected to the head rinsing portion 6b.

Additionally, in FIGS. 2 to 4, solid lines represent positions when respective members of the first coating solution nozzle moving mechanism 17a, the second coating solution nozzle moving mechanism 17b, the edge rinsing device 40, and the suction device 43 are retreated, and dotted lines represent position when the respective members are coated or edge-rinsed.

As shown in FIGS. 2 to 4, when being coated, as seen from one main surface 2a of the substrate 2 to be processed, the first coating solution nozzle moving mechanism 17a and the second coating solution nozzle moving mechanism 17b are arranged in the 3 o'clock direction (on the right in FIG. 2) with respect to the center of the substrate 2 to be processed. Additionally, when being edge-rinsed, as seen from one main surface 2a of the substrate 2 to be processed, the edge rinsing device 40 is arranged in the 6 o'clock direction (in the downward direction in FIG. 2) with respect to the center of the substrate 2 to be processed, and the suction device 43 is arranged in the 7 to 9 o'clock direction (in the low left direction in FIG. 2).

Additionally, as shown in FIG. 4, when being retreated, the first coating solution nozzle moving mechanism 17a and the second coating solution nozzle moving mechanism 17b, and the edge rinsing device 40 and the suction device 43 are arranged so as to face each other with a sufficient interval therebetween across the substrate 2 to be processed in plan view so as not to cause a hindrance when replacement or the like of the substrate 2 to be processed is performed. Additionally, when being coated or edge-rinsed, the first coating solution nozzle moving mechanism 17a and the second coating solution nozzle moving mechanism 17b, and the edge rinsing device 40 and the suction device 43 are horizontally moved toward the substrate 2 to be processed from opposite directions, and are brought close to the substrate 2 to be processed. Thereby, the first coating solution nozzle moving mechanism 17a and the second coating solution nozzle moving mechanism 17b, and the edge rinsing device 40 and the suction device 43 are prevented from contact with each other when being moved.

The holding mechanism 3a holds the substrate 2 to be processed so that the thickness direction of the substrate 2 to be processed is a horizontal direction, and is composed of a chucking portion 11 to which the substrate 2 to be processed is attached, and a rotary shaft 12. The chucking portion 11 is provided at the end of the rotary shaft 12, the substrate 2 to be processed is fixed as the central opening of the substrate 2 to be processed is fitted into the chucking portion 11 so that the substrate 2 to be processed is rotated in a state where the substrate is integrated with the rotary shaft 12.

The rotational driving mechanism 3, as shown in FIG. 2, rotationally drives the substrate 2 to be processed which is held by the holding mechanism 3a around its axis (rotates one main surface 2a clockwise in this embodiment). The rotational driving mechanism 3, as shown in FIG. 3, includes a spindle motor 8, a spindle shaft 9 which is a driving shaft of the spindle motor 8, and a pulley 10 attached to the tip of the spindle shaft 9, and the spindle shaft 9 and the rotary shaft 12 of the holding mechanism 3a are adapted to rotate in conjunction with each other. Accordingly, when the spindle motor 8 is driven in the rotational driving mechanism 3 shown in FIG. 3, the rotary shaft 12 is rotationally driven, and the substrate 2 to be processed which is held by the rotary shaft 12 is rotated according to the rotational direction and rotation number of the spindle motor 8.

The first coating solution nozzle moving mechanism 17a and the second coating solution nozzle moving mechanism 17b are arms which extend in the horizontal direction. As shown in FIG. 4, the first coating solution nozzle moving mechanism 17a supports the first coating solution nozzle 18a and a first head rinsing solution nozzle 19a, and the second coating solution nozzle moving mechanism 17b supports the second coating solution nozzle 18b, and a second head rinsing solution nozzle 19b. Attachment portions 16a and 16b are formed at the distal ends of the first coating solution nozzle moving mechanism 17a and the second coating solution nozzle moving mechanism 17b, respectively. The first coating solution nozzle 18a and the first head rinsing solution nozzle 19a are attached to the surface of the attachment portion 16a of the first coating solution nozzle moving mechanism 17a which is arranged to face the substrate 2 to be processed. Additionally, the second coating solution nozzle 18b and the second head rinsing solution nozzle 19b are attached to the attachment portion 16b of the second coating solution nozzle moving mechanism 17b.

The first coating solution nozzle moving mechanism 17a moves the first coating solution nozzle 18a in a thickness direction (a right-left direction in FIG. 4) of the substrate 2 to be processed on one main surface 2a of the substrate 2 to be processed, and moves the first coating solution nozzle 18a in the horizontal direction (the right-left direction in FIG. 2 and a vertical direction in FIG. 4) which is a diameter direction of the substrate 2 to be processed along one main surface 2a while being separated from one main surface 2a of the substrate 2 to be processed. The second coating solution nozzle moving mechanism 17b moves the second coating solution nozzle 18b in the thickness direction (the right-left direction in FIG. 4) of the substrate 2 to be processed on the other main surface 2b of the substrate 2 to be processed, and moves the second coating solution nozzle 18b in the horizontal direction (the right-left direction in FIG. 2 and the vertical direction in FIG. 4) which is the diameter direction of the substrate 2 to be processed along the other main surface 2b while being separated from the other main surface 2b of the substrate 2 to be processed.

As shown in FIG. 4, the second coating solution nozzle moving mechanism 17b and the first coating solution nozzle moving mechanism 17a are symmetrically arranged with respect to the thickness center plane of the substrate 2 to be processed, and the first coating solution nozzle 18a and the second coating solution nozzle 18b are adapted to move in conjunction with each other symmetrically with respect to the thickness center plane of the substrate 2 to be processed, by the second coating solution nozzle moving mechanism 17b and the first coating solution nozzle moving mechanism 17a.

The first coating solution nozzle 18a and the second coating solution nozzle 18b jet a coating solution simultaneously toward both the main surfaces 2a and 2b of the substrate 2 to be processed. The first coating solution nozzle 18a jets a coating solution onto one main surface 2a of the substrate 2 to be processed, and the second coating solution nozzle 18b jets the coating solution onto the other main surface 2b of the substrate 2 to be processed. The coating solution is supplied to the first coating solution nozzle 18a and the second coating solution nozzle 18b by the coating solution supply device 20 shown in FIG. 2.

The coating solution supply device 20 includes a coating solution tank 20a, and coating solution piping 20b which connects the first coating solution nozzle 18a and the second coating solution nozzle 18b with the coating solution tank 20a, and a coating solution valve 20c. The coating solution jetting amount, coating solution jetting time, jetting number-of-times, and the like from the first coating solution nozzle 18a and the second coating solution nozzle 18b are controlled by the opening/closing operation of the coating solution valve 20c.

The coating solution includes a solution obtained by dissolving various resists made of ultraviolet-curable resins, such as an ultraviolet-curable acrylic ester resin in a solvent.

Additionally, the amount of a coating solution jetted onto an inner peripheral portion of the substrate 2 to be processed by the first coating solution nozzle 18a and the second coating solution nozzle 18b becomes larger than the amount of the coating solution jetted onto the outer peripheral portion thereof by the first and second coating solution nozzles.

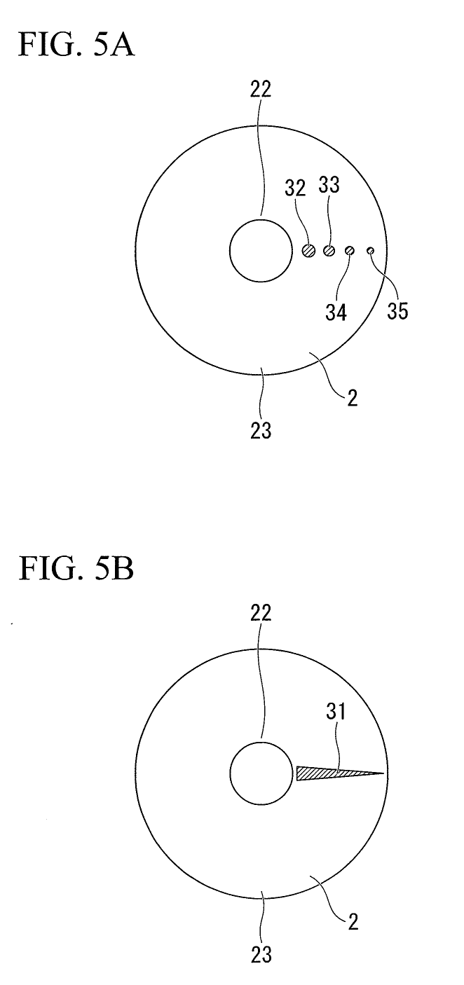

An example of such a first coating solution nozzle 18a and second coating solution nozzle 18b will be described with reference to FIGS. 5A and 5B. FIGS. 5A and 5B are views for explaining the shape of a coating solution jetting port of the first coating solution nozzle 18a and/or the second coating solution nozzle 18b. In addition, in FIGS. 5A and 5B, in order to explain the correspondence relationship between the substrate 2 to be processed, and the shape of the coating solution jetting ports of the first coating solution nozzle 18a and the second coating solution nozzle 18b which face the substrate 2 to be processed, the substrate 2 to be processed which is arranged to face the coating solution jetting ports are shown along with the shape (shaded portion) of the coating solution jetting ports.

In the example shown in FIG. 5A, four coating solution jetting ports 32, 33, 34, and 35 are aligned from a position which faces the outer peripheral portion 23 of the substrate 2 to be processed toward a position which faces the inner peripheral portion 22 thereof.

In the example shown in FIG. 5A, the four coating solution jetting ports 32, 33, 34, and 35 are all circular, a coating solution jetting port on the side of the outer peripheral portion 23 is made to have a smaller area, and a coating solution jetting port on the side of the inner peripheral portion 22 is made to have a larger area.

In addition, although the number of coating solution jetting ports is set to four in the example shown in FIG. 5A, two or three coating solution jetting ports may be provided or five or more coating solution jetting ports may be provided, so long as the number of coating solution jetting ports which are aligned from the position which faces the outer peripheral portion 23 of the substrate 2 to be processed toward the position which faces the inner peripheral portion 22 thereof is plural. Additionally, a coating solution jetting port of which the area is smaller can stably supply a coating solution as compared to a coating solution jetting port of which the area is larger.

Accordingly, in the four coating solution jetting ports 32, 33, 34, and 35 shown in FIG. 5A, a coating solution can be stably supplied as compared to a case where the number of coating solution jetting ports is one, and the total area of the coating solution jetting ports is the same. Additionally, in the example shown in FIG. 5A, the shape of all the coating solution jetting ports 32, 33, 34, and 35 are made circular so as to be able to stably supply a coating solution. However, the shape of the coating solution jetting ports may not be circular. For example, the shape of the coating solution jetting ports may be an isosceles triangle or the like in which an apex is arranged toward the outer peripheral portion 23, and a base is arranged toward the inner peripheral portion 22, and is not particularly limited.

Additionally, in the example shown in FIG. 5B, the coating solution jetting port 31 has a shape in which the width of jetting port 31 in the circumferential direction of the substrate 2 to be processed becomes gradually larger from the position which faces the outer peripheral portion 23 of the substrate 2 to be processed toward the position which faces the inner peripheral portion 22. In the example shown in FIG. 5B, the shape of the coating solution jetting ports 31 is an isosceles triangle in which an apex is arranged toward the outer peripheral portion 23, and a base is arranged toward the inner peripheral portion 22.

In addition, in the example shown in FIGS. 5A and 5B, the amount of a coating solution jetted onto the inner peripheral portion 22 is intended to become larger than the amount of the coating solution jetted onto the outer peripheral portion 23 of the substrate 2 to be processed, by changing the shape of the coating solution jetting ports. However, for example, the amount of the coating solution jetted onto the inner peripheral portion 22 of the substrate 2 to be processed may be made to become more than the amount of the coating solution jetted onto the outer peripheral portion 23 by providing two coating solution jetting ports with the same area composed of a coating solution jetting port jetted onto the outer peripheral portion 23 and a coating solution jetting port jetted onto the inner peripheral portion 22 are provided as the coating solution jetting ports, and making the pressure of a coating solution from the coating solution jetting port jetted onto the outer peripheral portion 23 lower than the pressure of the coating solution from the coating solution jetting port jetted onto the inner peripheral portion 22.

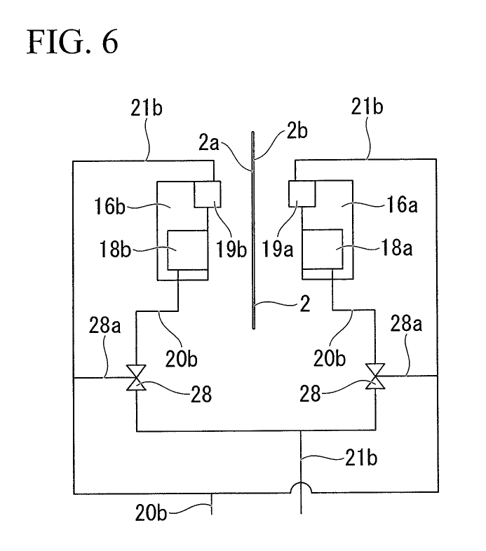

The first head rinsing solution nozzle 19a and the second head rinsing solution nozzle 19b jet a rinsing solution which is a cleaning solution for cleaning the first coating solution nozzle 18a and/or the second coating solution nozzle 18b. The first and second head rinsing solution nozzles 19a and 19b protrude in a direction in which the nozzles face in the substrate 2 to be processed and are attached to the attachment portions 16a and 16b of the first and second coating solution nozzle moving mechanisms 17a and 17b, and as shown in FIG. 4, are arranged so as to overhang in a direction in which the nozzles face the substrate 2 to be processed, more than the first and second coating solution nozzles 18a and 18b. Additionally, the first head rinsing solution nozzle 19a, as shown in FIG. 6, is attached above the first coating solution nozzle 18a, and the second head rinsing solution nozzle 19b is attached above the second coating solution nozzle 18b.

Accordingly, when the first head rinsing solution nozzle 19a (second head rinsing solution nozzle 19b) cleans the first coating solution nozzle 18a (second coating solution nozzle 18b), a rinsing solution is preferably jetted downward from the first head rinsing solution nozzle 19a (second head rinsing solution nozzle 19b).

Additionally, when the first head rinsing solution nozzle 19a (second head rinsing solution nozzle 19b) cleans the second coating solution nozzle 18b (first coating solution nozzle 18a), a rinsing solution is preferably jetted obliquely downward toward the front from the first head rinsing solution nozzle 19a (second head rinsing solution nozzle 19b).

Additionally, when the first head rinsing solution nozzle 19a (second head rinsing solution nozzle 19b) cleans the first coating solution nozzle 18a and the second coating solution nozzle 18b, a rinsing solution is preferably jetted obliquely downward toward the front from the first head rinsing solution nozzle 19a (second head rinsing solution nozzle 19b).

A rinsing solution is supplied to the first head rinsing solution nozzle 19a and the second head rinsing solution nozzle 19b by the rinsing solution supply device 21 shown in FIG. 2.

As a rinsing solution, a solution capable of dissolving and removing a coating solution (and a coating film) is used. Specifically, the rinsing solution includes acetone or the like.

The rinsing solution supply device 21 includes a rinsing solution tank 21a, rinsing solution piping 21b which connects the rinsing solution tank 21a with the first head rinsing solution nozzle 19a and the second head rinsing solution nozzle 19b, and a rinsing solution valve 21c. As shown in FIG. 6, the rinsing solution piping 21b branches at a position nearer to the first and second head rinsing solution nozzles 19a and 19b than the rinsing solution valve 21c so that a rinsing solution can be supplied to the first head rinsing solution nozzle 19a and the second head rinsing solution nozzle 19b, respectively. The rinsing solution jetting amount and rinsing solution jetting time from the first head rinsing solution nozzle 19a and the second head rinsing solution nozzle 19b are controlled by the opening/closing operation of the rinsing solution valve 21c.

Additionally, as shown in FIGS. 2 and 6, the rinsing solution piping 21b is connected to the coating solution piping 20b of the coating solution supply device 20 by connection piping 28a. A switching valve 28 is connected to the end portion of the connection piping 28a on the side of the coating solution piping 20b. In the double-side coating apparatus 1 of this embodiment, a coating solution is supplied to the first coating solution nozzle 18a and the second coating solution nozzle 18b by changing the switching valve 28 when being coated. Additionally, when the line cleaning which will be described later is performed, a rinsing solution is supplied to the coating solution piping 20b on the side of the first and second coating solution nozzles 18a and 18b, and the first and second coating solution nozzles 18a and 18b, from the switching valve 28.

Additionally, the rinsing solution supply device 21 includes branch piping 21d which branches from the rinsing solution piping 21b and is connected to a container 41, and a rinsing solution valve 21e, in order to supply a rinsing solution to the container 41 of the edge rinsing device 40 which will be described later. The supply amount of a rinsing solution to the container 41 is controlled by the opening/closing operation of the rinsing solution valve 21e.

As shown in FIGS. 2 and 4, the first coating solution nozzle 18a, and the second coating solution nozzle 18b are brought close to the substrate 2 to be processed by the movement of the first coating solution nozzle moving mechanism 17a and the second coating solution nozzle moving mechanism 17b when being coated, and are separated from the substrate 2 to be processed when the substrate 2 to be processed is detached, or when the first coating solution nozzle 18a and the second coating solution nozzle 18b are cleaned.

More specifically, when being coated, the first coating solution nozzle 18a and the second coating solution nozzle 18b are moved by the first coating solution nozzle moving mechanism 17a and the second coating solution nozzle moving mechanism 17b, and the position of the first coating solution nozzle 18a with respect one main surface 2a of the substrate 2 to be processed and the position of the second coating solution nozzle 18b with respect to the other main surface 2b of the substrate 2 to be processed are determined at predetermined positions. Thereby, as shown in FIGS. 2 and 6, the first coating solution nozzle 18a and the second coating solution nozzle 18b are symmetrically arranged with respect to the thickness center plane of the substrate 2 to be processed so that as to pinch the substrate 2 to be processed which rotates downward.

Accordingly, in the double-side coating apparatus 1 of this embodiment, a coating solution is simultaneously supplied to the same position in both the main surfaces 2a and 2b of the substrate 2 to be processed by jetting the coating solution simultaneously toward the substrate 2 to be processed from the first coating solution nozzle 18a and the second coating solution nozzle 18b.

Additionally, when the substrate 2 to be processed is detached, the first coating solution nozzle 18a and the second coating solution nozzle 18b can be retreated into the head rinsing portion 6b provided in the substrate-to-be processed housing portion 6 by the first coating solution nozzle moving mechanism 17a and the second coating solution nozzle moving mechanism 17b.

Additionally, when a rinsing solution is jetted from the first head rinsing solution nozzle 19a and the second head rinsing solution nozzle 19b, the first coating solution nozzle 18a and the second coating solution nozzle 18b can be moved into the head rinsing portion 6b. By jetting a rinsing solution from the first head rinsing solution nozzle 19a and the second head rinsing solution nozzle 19b within the head rinsing portion 6b in this way, a waste liquid generated by the cleaning of the first coating solution nozzle 18a and the second coating solution nozzle 18b or the line cleaning which will be described later can be prevented from being scattered into the main body 6a of the substrate-to-be processed housing portion 6.

In addition, the double-side coating apparatus 1 including the first coating solution nozzle moving mechanism 17a and the second coating solution nozzle moving mechanism 17b which support and move the first coating solution nozzle 18a and the second coating solution nozzle 18b has been described as an example, in this embodiment. However, the first coating solution nozzle moving mechanism 17a and the second coating solution nozzle moving mechanism 17b may not be included if the substrate 2 to be processed can be detached without moving the first coating solution nozzle 18a and the second coating solution nozzle 18b. In this case, the first coating solution nozzle 18a and the second coating solution nozzle 18b can be fixed at predetermined positions within the main body 6a in the substrate-to-be processed housing portion 6.

The edge rinsing device 40 is for removing (edge rinsing) any extra coating solution adhering to outer edges of both the main surfaces 2a and 2b of the substrate 2 to be processed where the coating solution is coated. As shown in FIGS. 2 to 4, the edge rinsing device 40 includes the container 41 which stores a rinsing solution. As shown in FIG. 4, an opening 41a is formed in the top surface of the container 41 so that the liquid level of the rinsing solution is exposed through the top surface of the container 41. The width of the opening 41a of the container 41 in the thickness direction of the substrate 2 to be processed, as shown in FIG. 4, is larger than the thickness of the substrate 2 to be processed.

A rinsing solution is supplied to the container 41 by the rinsing solution supply device 21 shown in FIG. 2. Additionally, as shown in FIG. 2, a liquid discharge device 25g including a waste liquid tank 25d, liquid discharge piping 25e which connects the container 41 with the waste liquid tank 25d, and a liquid discharge valve 25f is connected to the container 41.

Additionally, the edge rinsing device 40 is provided with a container moving mechanism 42 which is an arm which extends in the horizontal direction, and supports the container 41 and moves the container 41 in the horizontal direction and in the vertical direction. As shown in FIG. 2, the container 41 of the edge rinsing device 40 is brought close to the substrate 2 to be processed by the container moving mechanism 42 when being edge-rinsed, and is separated from the substrate 2 to be processed when the substrate 2 to be processed is detached, and when being coated.

More specifically, when being edge-rinsed, the container 41 is moved into the main body 6a from outside the substrate-to-be processed housing portion 6 by the container moving mechanism 42, and as shown in FIGS. 2 to 4, the container 41 is arranged at a position where the revolving outer edge of the substrate 2 to be processed is immersed in a rinsing solution from the bottom. Thereby, the outer edges of both the main surfaces 2a and 2b of the substrate 2 to be processed are immersed in a rinsing solution, and any extra coating solution adhering to the outer edges of the substrate 2 to be processed is removed.

Additionally, when the substrate 2 to be processed is detached, the container 41 can be retreated to the outside of the substrate-to-be processed housing portion 6 by the container moving mechanism 42. Accordingly, the container 41 can easily perform detachment of the substrate 2 to be processed, without deteriorating the workability when the substrate 2 to be processed is detached.

Additionally, when being coated, the container 41 can be made to stand by in the vicinity of the substrate 2 to be processed within the main body 6a of the substrate-to-be processed housing portion 6. Here, the vicinity of the substrate 2 to be processed device that the distance between the substrate 2 to be processed and the liquid level of a rinsing solution is within a range of 0.5 cm to 10 cm. If the distance between the substrate 2 to be processed and the liquid level of a rinsing solution is nearer than the above range, since the rinsing solution is apt to be contaminated by a coating solution which is scattered when being coated, this is not preferable. Additionally, when the distance between the substrate 2 to be processed and the liquid level of a rinsing solution is nearer than the above range, the substrate 2 to be processed and the liquid level of the rinsing solution may contact with each other by the number of rotations at the time of unsuitable coating in performing edge rinsing. Thus, coating and edge rinsing may be unable to be performed with high precision. Additionally, if the distance between the substrate 2 to be processed and the liquid level of a rinsing solution is further than the above range, there is a case that the container 41 cannot be moved to a predetermined position until edge rinsing is started after the end of coating.

By making the container 41 stand by within the main body 6a of the substrate-to-be processed housing portion 6 when being coated, the moving distance and moving time of the container 41 during the edge rinsing performed after coating can be shortened. In addition, the container 41 may be retreated to the outside of the substrate-to-be processed housing portion 6 similarly when the substrate 2 to be processed is detached, even when being coated. In this case, a rinsing solution can be prevented from being contaminated by a coating solution which is scattered when being coated.

The suction device 43 includes a suction part 43a which sucks fine misty droplets consisting of a rinsing solution, which are generated during the edge rinsing of the substrate 2 to be processed, and sucks gas within the apparatus when being edge-rinsed, thereby controls the flow of gas within the apparatus when being edge-rinsed.

As shown in FIG. 4, a slit 43b composed of a groove is formed at the center portion of the suction part 43a in the thickness direction of the substrate 2 to be processed, and a suction port (not shown) connected to a suction device is provided in the slit 43b. Thereby, it is possible to more effectively prevent the fine misty droplets consisting of a rinsing solution, which are generated during the edge rinsing of the substrate 2 to be processed, from being scattered, and adhering to the substrate 2 to be processed, and the flow of the gas to the substrate 2 to be processed when being edge-rinsed can be more effectively stabilized.

As the suction device, any type of such devices may be used long as the suction devices can suck the fine misty droplets consisting of a rinsing solution, which are generated during the edge rinsing of the substrate 2 to be processed, and can suck gas within the apparatus when being edge-rinsed. However, it is preferable to use a suction device of which the suction power is 1-10 m³/min.

Additionally, a waste liquid tank (not shown) is connected to the suction device via piping (not shown) for discharging a liquid. In addition, the liquid discharge device 25g connected to the container 41 of the edge rinsing device 40 may be connected to the suction device.

Additionally, as shown in FIGS. 2 and 4, an inner wall surface 43c, which is a bottom portion of the slit 43b, which faces a side surface of the substrate 2 to be processed is made circular-arc shaped in cross-section view so that, when the substrate 2 to be processed which has been edge-rinsed is pinched into the slit 43b, the distance between the side surface of the substrate 2 to be processed and the inner wall surface 43c becomes the equal distance. Thereby, the flow of gas to the substrate 2 to be processed when being edge-rinsed can be more effectively stabilized.

Additionally, in an outer wall 43d of the suction part 43a on the side of the side surface of the substrate 2 to be processed shown in FIG. 4, as shown in FIG. 2, the width seen from the main surface of the substrate 2 to be processed becomes gradually larger downward from the top so that the bottom surface of the suction part 43a faces the container 41.

Thereby, the suction part 43a is adapted to be able to effectively prevent scattering of fine misty droplets consisting of a rinsing solution, which are generated from the edge rinsing device 40.

Additionally, the suction device 43 is provided with a suction part moving mechanism 44 which supports the suction part 43a, and moves the suction part 43a in the horizontal direction and in the vertical direction. In this embodiment, as shown in FIG. 2, the suction part moving mechanism 44 is fixed to and integrated with the container moving mechanism 42, and the suction part moving mechanism 44 is moved so as to interlock with the container moving mechanism 42. Accordingly, in this embodiment, the edge rinsing device 40 and the suction device 43 are moved in an integrated state so that the positional relationship between the edge rinsing device 40 and the suction device 43 do not shift due to the movement. In the integrated edge rinsing device 40 and suction device 43, as shown in FIG. 4, alignment is performed so that the center of the width of the opening 41a of the container 41 in the thickness direction of the substrate 2 to be processed and the center of the width of the slit 43b in the thickness direction of the substrate 2 to be processed coincide with each other.

In addition, although the suction part moving mechanism 44 and the container moving mechanism 42 are integrated, they may be individually provided.

In this embodiment, as shown in FIG. 2, the suction part 43a of the suction device 43 is brought to the substrate 2 to be processed by the suction part moving mechanism 44 (container moving mechanism 42) when being edge-rinsed, and is separated from the substrate 2 to be processed when the substrate 2 to be processed is detached or when being coated.

More specifically, when being edge-rinsed, the suction part 43a is moved into the main body 6a from outside the substrate-to-be processed housing portion 6 along with the edge rinsing device 40 by the suction part moving mechanism 44 (container moving mechanism 42), the suction part 43a is arranged adjacent to the edge rinsing device 40 at a side of the edge rinsing device 40 wherein the side is the side of the rotational direction (clockwise direction in FIG. 2) of the substrate 2 to be processed, and the substrate 2 to be processed is pinched into the slit 43b of the suction part 43a. Thereby, the suction part 43a can be made to suck fine misty droplets consisting of a rinsing solution, which are generated during the edge rinsing of the substrate 2 to be processed, and the suction part 43a can be made to suck gas within the apparatus when being edge-rinsed. Accordingly, a failure which occurs as fine misty droplets consisting of a rinsing solution adhere to the substrate 2 to be processed can be reduced, and edge rinsing can be performed in a stable gas atmosphere in which the flow of gas to the substrate 2 to be processed when being edge-rinsed is controlled.

Additionally, when the substrate 2 to be processed is detached, the suction part 43a is retreated to the outside of the substrate-to-be processed housing portion 6 along with the edge rinsing device 40 by the suction part moving mechanism 44 (container moving mechanism 42). Accordingly, the suction part 43a can easily perform detachment of the substrate 2 to be processed, without deteriorating the workability when the substrate 2 to be processed is detached.

Additionally, the suction part 43a is made to stand by in the vicinity of the substrate 2 to be processed within the main body 6a of the substrate-to-be processed housing portion 6 along with the edge rinsing device 40 when being coated. Thereby, the moving distance and moving time of the suction part 43a during the edge rinsing performed after coating can be shortened.

<Manufacture of Discrete Magnetic Recording Medium>

Next, a case where a method for coating double sides with a coating solution using the double-side coating apparatus 1 shown in FIG. 2 is applied to a resist layer forming step in a method of manufacturing the discrete magnetic recording medium shown in FIG. 1 will be described.

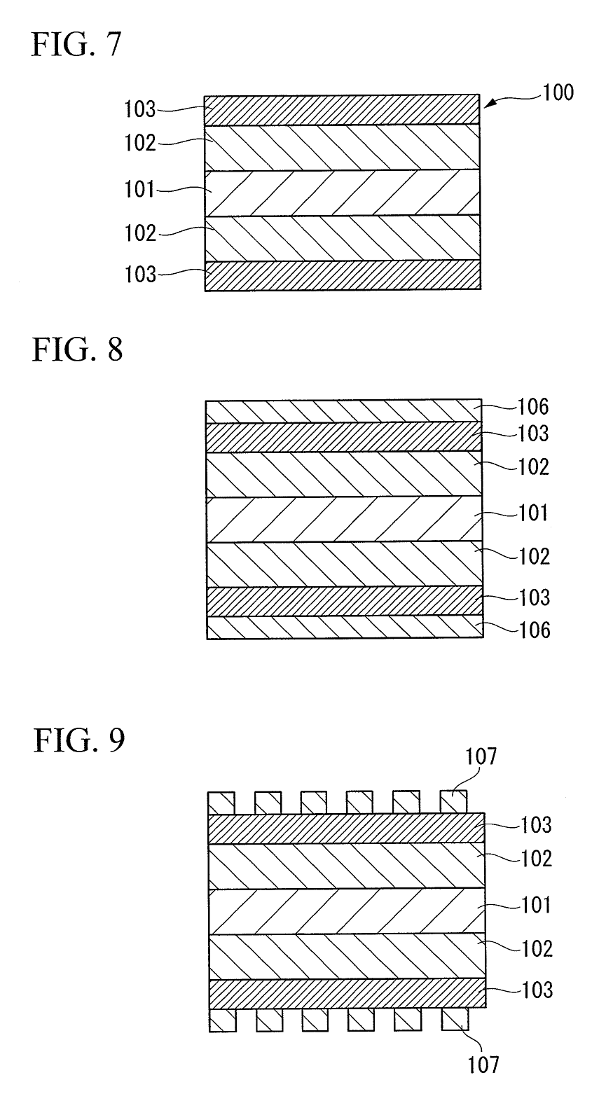

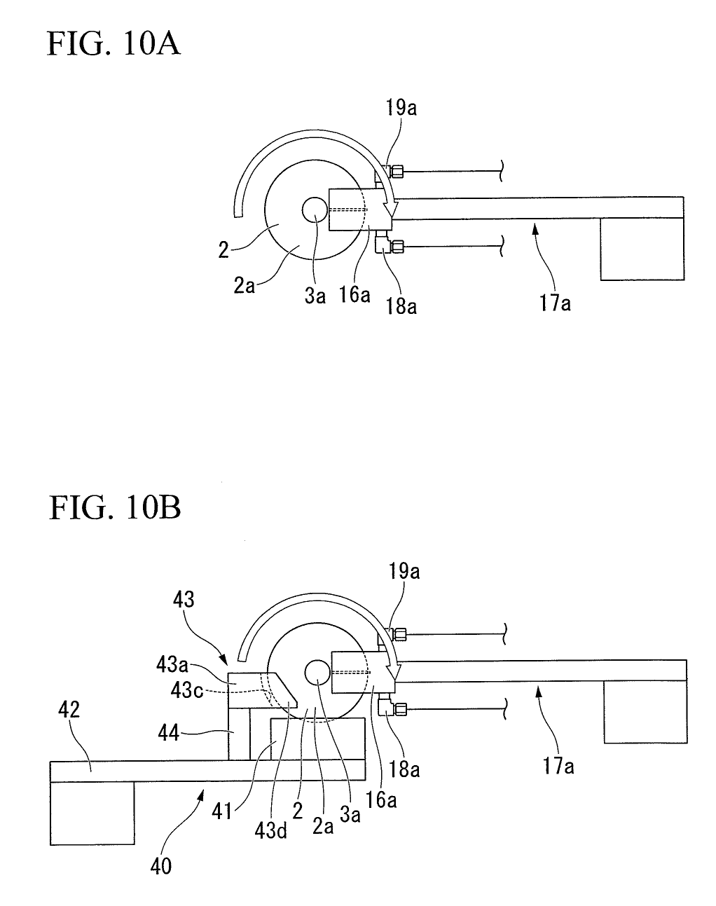

FIGS. 7 to 9 are process drawings for explaining the process of manufacturing the discrete magnetic recording medium shown in FIG. 1. Additionally, FIGS. 10A and 10B are views for explaining the operation of the double-side coating apparatus 1 shown in FIG. 2, and are front views seen from one main surface 2a of the substrate 2 to be processed.

In order to manufacture the discrete magnetic recording medium shown in FIG. 1, first, the foundation layer 102 composed of a soft magnetic layer, an intermediate layer, and the like is formed ion both the main surfaces of the nonmagnetic substrate 101 having a central opening, according to an ordinary method. Next, the magnetic layer 103 is formed on the foundation layer 102. The magnetic layer 103 is formed throughout the top surface of the foundation layer 102 as a thin film, for example, by film-forming methods, such as a sputtering method. As shown in FIG. 7, the substrate 101 to be magnetized in which the foundation layer 102 and the magnetic layer 103 are formed is obtained in the above-described manner.

Next, a resist layer is formed throughout the surface of the magnetic layer 103 shown in FIG. 7. Here, the formation of the resist layer is performed as follows, using the substrate 101 to be magnetized in which the foundation layer 102 and the magnetic layer 103 shown in FIG. 7 are formed as the substrate 2 to be processed, and using the double-side coating apparatus 1 shown in FIG. 2.

First, as shown in FIG. 2, the first coating solution nozzle 18a and the second coating solution nozzle 18b which constitute the double-side coating apparatus 1 is retreated into the head rinsing portion 6b provided in the substrate-to-be processed housing portion 6 by the first coating solution nozzle moving mechanism 17a and the second coating solution nozzle moving mechanism 17b. Additionally, as shown in FIG. 2, the container 41 and the suction part 43a are retreated to the outside of the substrate-to-be processed housing portion 6 by the container moving mechanism 42 (suction part moving mechanism 44).

Next, the central opening of the substrate 2 to be processed is fitted into the chucking portion 11 of the holding mechanism 3a, and the substrate 2 to be processed is fixed to the holding mechanism 3a so that the thickness direction of the substrate 2 to be processed becomes the horizontal direction. Thereby, the substrate 2 to be processed is integrated with the rotary shaft 12.

Next, a coating solution is coated onto one main surface 2a and other main surface 2b of the substrate 2 to be processed. First, the spindle motor 8 of the rotational driving mechanism 3 is driven so that one main surface 2a of the substrate 2 to be processed is rotated clockwise. Although the rotation number of the substrate 2 here to be processed is not particularly limited, it is preferable to set the rotation number of the substrate 2 when being coated to be processed to several hundreds of rpm to 1000 rpm so as to be able to sufficiently suppress the influence of gravity on the coating solution supplied to the substrate 2 to be processed, and obtain a coating film having a uniform and sufficient film thickness.

Next, as shown in FIG. 10A, the first coating solution nozzle 18a and the second coating solution nozzle 18b are moved by the first coating solution nozzle moving mechanism 17a and the second coating solution nozzle moving mechanism 17b, and the first coating solution nozzle 18a and the second coating solution nozzle 18b are arranged symmetrically with respect to the thickness center plane of the substrate 2 to be processed so as to pinch the substrate 2 to be processed. Additionally, the edge rinsing device 40 and the suction part 43a are moved to the vicinity of the substrate 2 to be processed within the main body 6a from outside the substrate-to-be processed housing portion 6 by the suction part moving mechanism 44 (container moving mechanism 42).

Thereafter, the coating solution valve 20c is opened to jet a coating solution toward the main surface 2a and other main surface 2b of the substrate 2 to be processed which rotates downward from the top between the first coating solution nozzle 18a and the nozzles 18b for the second the coating solution from the first coating solution nozzle 18a and the second coating solution nozzle 18b, and to spread the coating solution on both the main surfaces 2a and 2b of the substrate 2 to be processed.

Next, the first coating solution nozzle 18a and the second coating solution nozzle 18b is retreated into the head rinsing portion 6b provided in the substrate-to-be processed housing portion 6 by the first coating solution nozzle moving mechanism 17a and the second coating solution nozzle moving mechanism 17b.

Thereafter, the rotation number of the substrate 2 to be processed is set to about 4000 to 5000 rpm, and any extra coating solution adhering to the substrate 2 to be processed is shaken off, and made uniform.

Additionally, the retreated first coating solution nozzle 18a and second coating solution nozzle 18b are cleaned within the head rinsing portion 6b if needed. It is desirable that the cleaning of the first coating solution nozzle 18a and the second coating solution nozzle 18b be performed, for example, whenever one substrate 2 to be processed is coated.

The cleaning of the first coating solution nozzle 18a and the second coating solution nozzle 18b is performed by jetting a rinsing solution from the first head rinsing solution nozzle 19a and/or the second head rinsing solution nozzle 19b. The cleaning of the first coating solution nozzle 18a and the second coating solution nozzle 18b is preferably performed by jetting a rinsing solution from a head rinsing solution nozzle on the facing side (that is, from the second head rinsing solution nozzle 19b in the case of the first coating solution nozzle 18a) because the rinsing solution can be supplied to the first and second coating solution nozzles 18a and 18b obliquely from the top front, thereby effectively performing cleaning. However, the cleaning may be performed by jetting a rinsing solution downward from a head rinsing solution nozzle on the same side (that is, from the first head rinsing solution nozzle 19a in the case of the first coating solution nozzle 18a), or both rinsing methods may be performed.

By performing the cleaning of the first coating solution nozzle 18a and the second coating solution nozzle 18b, clogging of the first coating solution nozzle 18a and the second coating solution nozzle 18b can be prevented, and variation in the amount of jetting, which is caused when a coating solution or a coating film adheres to the first coating solution nozzle 18a and the second coating solution nozzle 18b, can be prevented.

Additionally, in this embodiment, it is preferable to perform the line cleaning (a coating solution piping cleaning step) of switching the switching valve 28 whenever several to ten or more substrates 2 to be processed are coated, thereby cleaning the coating solution piping 20b nearer to the first and second coating solution nozzles 18a and 18b than the switching valve 28, and the first and second coating solution nozzles 18a and 18b. The line cleaning is preferably performed even before or after use of the double-side coating apparatus 1 is stopped for a prolonged period of time.

By performing the line cleaning, variation in the amount of jetting, which is caused when a coating solution or a coating film adheres to the coating solution piping 20b nearer to the first and second coating solution nozzles 18a and 18b than the switching valve 28, and the first and second coating solution nozzles 18a and 18b, can be prevented.

In addition, in this embodiment, the rotation of the substrate 2 to be processed is started before the first coating solution nozzle 18a and the second coating solution nozzle 18b are moved. However, the rotation of the substrate 2 to be processed may be started after the first coating solution nozzle 18a and the second coating solution nozzle 18b are moved, and a coating solution may be jetted from the first coating solution nozzle 18a and the second coating solution nozzle 18b after a predetermined rotating speed is reached. Additionally, when any extra coating solution adhering to the substrate 2 to be processed is shaken off after the first coating solution nozzle 18a and the second coating solution nozzle 18b are retreated, any extra coating solution adhering to the substrate 2 to be processed can be prevented from adhering to the first coating solution nozzle 18a and the second coating solution nozzle 18b, this is desirable. However, the first coating solution nozzle 18a and the second coating solution nozzle 18b may be retreated after any extra coating solution is shaken off. Additionally, as shown in FIG. 10B, the edge rinsing may be performed without retreating the first coating solution nozzle 18a and the second coating solution nozzle 18b, and the first coating solution nozzle 18a, and the second coating solution nozzle 18b may be retreated after the edge rinsing is ended.

Next, the extra coating solution adhering to the outer edge of the substrate 2 to be processed is removed (edge-rinsed). The rotation number of the substrate 2 to be processed when being edge-rinsed is preferably set to about 500 to 3000 rpm. If the rotation number of the substrate 2 to be processed when being edge-rinsed is less than the above range, the rinsing solution may enter the inside of the substrate 2 to be processed due to its surface tension and gravity, and dripping of the rinsing solution may occur. Additionally, if the rotation number of the substrate 2 to be processed when being edge-rinsed exceeds the above range, liquid scattering of the rinsing solution may occur when the substrate 2 to be processed and the rinsing solution has contacted each other, the scattered rinsing solution may adhere to the surface of the substrate 2 to be processed, and melting of the resist may occur in the adhesion spot.

Additionally, the time taken until the edge rinsing is started (the outer edge of the substrate 2 to be processed is immersed in a rinsing solution) after the jetting of the coating solution is ended is preferably set to about 1 second to 10 minutes. If the time taken until the edge rinsing is started after the jetting of the coating solution is ended is shorter than the above range, there is a case that the first coating solution nozzle 18a and the second coating solution nozzle 18b cannot be retreated. Additionally, although the liquid level of the rinsing solution vibrates due to the movement of the container 41, if the time taken until the edge rinsing is started is shorter than the above range, the vibration of the liquid level of the rinsing solution caused by the movement of the container 41 is not settled, and the liquid level state of the rinsing solution is not stable. Moreover, if the time taken until the edge rinsing is started is shorter than the above range, the coating solution may remain within the substrate-to-be processed housing portion 6. Additionally, if the time taken until the edge rinsing is started after the jetting of the coating solution is ended is longer than the above range, drying of the coating solution may proceed, and any extra coating solution may be hardly removed.

The edge rinsing is performed by moving the edge rinsing device 40 and the suction part 43a into the main body 6a from outside the substrate-to-be processed housing portion 6 by the suction part moving mechanism 44 (container moving mechanism 42), arranging the container 41 at a position where 0.1 mm to 0.2 mm of the lower outer edge of the substrate 2 to be processed which is rotating is immersed in a rinsing solution, arranging the suction part 43a adjacent to the edge rinsing device 40, at the position of the edge rinsing device 40 on the side of the rotational direction of the substrate 2 of to be processed, and making the substrate 2 to be processed pinched into the slit 43b of the suction part 43a. Thereby, the outer edges of the substrate 2 to be processed are immersed in a rinsing solution, and any extra coating solution adhering to the outer edges of the substrate 2 to be processed is simultaneously removed. Additionally, fine misty droplets consisting of a rinsing solution are generated when being edge-rinsed, and gas within the apparatus when being edge-rinsed is sucked by the suction part 43a.

The time taken until the edge rinsing is ended after being started (the time during which a portion of substrate 2 to be processed is immersed in a rinsing solution) is preferably set to about 1 to 10 seconds. If the time taken until the edge rinsing is ended after being started is less than one second, any extra coating solution which has adhered may not be sufficiently removed. Additionally, If the time taken until the edge rinsing is ended after being started exceeds 10 seconds, since the effect of the edge rinsing does not improve, and the productivity decreases, this is not preferable.

Thereafter, the container 41 and the suction part 43a are retreated to the outside of the substrate-to-be processed housing portion 6 by the container moving mechanism 42 (suction part moving mechanism 44).

The cross-sectional structure of the substrate 101 to be magnetized in which the resist layer 106 is formed in the above-described manner is shown in FIG. 8.

Next, as shown in FIG. 9, the resist layer 106 is patterned in a planar shape corresponding to a magnetic recording pattern to form a resist pattern 107.

As a method of patterning the resist layer 106, a method of bringing a stamp into close contact with the resist layer 106 directly from above the resist layer, thereby pressing the resist layer with high pressure, or the like can be used. Additionally, in a case where an ultraviolet-curable resin is used as the resist, pattern formation may be performed by applying photolithography.

As the stamp used when the resist layer 106 is patterned, for example, a stamp obtained by forming a fine track pattern on a metal plate, using methods, such as electron-beam drawing, can be used. Specifically, for example, an Ni stamp or the like can be used as the stamp. A pattern of servo signals, such as a burst pattern, a gray code pattern, or a preamble pattern, other than a track which records normal data, can also be formed on the stamp.

Next, the magnetic properties of the magnetic layer 103 in a region where the resist pattern 107 is not formed are reformed, the reforming portion 104 which is a nonmagnetic portion where the magnetic properties of the magnetic layer 103 are reformed is formed, and a region where the magnetic recording pattern is magnetically separated is formed. The reforming of the magnetic properties of the magnetic layer 103 can be performed by exposing the substrate 101 to be magnetized in which the resist pattern 107 is formed on the magnetic layer 103 to reactive plasma. As the reactive plasma, inductively coupled plasma (ICP), reactive ion plasma (RIE), and the like can be exemplified.

Next, the resist pattern 107 is removed. The removal of the resist pattern 107 can be performed using techniques, such as dry etching, reactive ion etching, ion milling, and wet etching.

Next, the protective film 105 and the lubricant layer are formed on the magnetic layer 103. The protective film 105 can generally be formed by a method of forming a diamond-like carbon thin film, using a P-CVD method or the like. Additionally, the lubricant layer can be formed, for example, by drying a solution containing lubricant after being coated onto the surface of the protective film 105.

In such a method of manufacturing a discrete magnetic recording medium, a magnetic recording medium is manufactured by forming the resist pattern 107 made to match a magnetic recording pattern on the surface of the magnetic layer 103, subjecting the surface to the reactive plasma, and then removing the resist pattern 107 to form the protective layer 105 and the lubricant sequentially. In the magnetic recording medium 100 shown in FIG. 1, a magnetically separated magnetic recording pattern is obtained without forming irregularities on the nonmagnetic substrate 101. Thus, the smoothness of a surface is excellent, and low floating of a magnetic head can be realized.

However, the method of manufacturing a discrete magnetic recording medium is not limited to the above-described method. For example, the following methods may be used.

That is, a protective layer may be formed on a magnetic layer, a resist pattern made to match a magnetic recording pattern may be formed on the surface of the protective layer, using the double-side coating apparatus of the invention, and then reforming treatment of the magnetic layer by the reactive plasma may be performed. In such a method, it is not necessary to form a protective film after the reactive plasma treatment, and the effects of improvement in productivity and reduction in contamination in the process of manufacturing a magnetic recording medium are obtained. In addition, the present inventors confirmed that it is possible to cause the reaction between the magnetic layer and the reactive plasma after the protective film is formed on the surface of the magnetic layer.

The double-side coating apparatus 1 of this embodiment includes the holding mechanism 3a which holds the substrate 2 to be processed so that the thickness direction of the substrate 2 to be processed becomes the horizontal direction, the rotational driving mechanism 3 which rotates the substrate 2 to be processed in the circumferential direction, and the first coating solution nozzle 18a which jets a coating solution onto one main surface 2a of the substrate 2 to be processed, and the second coating solution nozzle 18b which jets the coating solution onto the other main surface 2b of the substrate 2 to be processed, and the first coating solution nozzle 18a and the second coating solution nozzle 18b are symmetrically arranged with respect to the thickness center plane of the substrate 2 to be processed. Thus, a coating solution is simultaneously supplied to the same position in both the main surfaces 2a and 2b of the substrate 2 to be processed by jetting the coating solution simultaneously toward the substrate 2 to be processed from the first coating solution nozzle 18a and the second coating solution nozzle 18b. Therefore, according to the double-side coating apparatus 1 of this embodiment, as there is no difference resulting from gravity in coating onto one main surface 2a of the substrate 2 to be processed, and coating onto the other main surface 2b, or difference resulting from coating positions, the coating solution can be uniformly coated onto both the surfaces of the substrate 2 to be processed, and uniform coating films can be formed on both the surfaces of the substrate 2 to be processed.

Additionally, in the double-side coating apparatus 1 of this embodiment, the first coating solution nozzle 18a and the second coating solution nozzle 18b jet a coating solution to the inner peripheral portion 22 and outer peripheral portion 23 of the substrate 2 to be processed. For example, as compared to the case where the first coating solution nozzle 18a and the second coating solution nozzle 18b jet a coating solution only to the inner peripheral portion 22, the time for which the coating solution spreads in both the main surfaces 2a and 2b of the substrate 2 to be processed is short, and coating can be performed at high speed.

Additionally, in the double-side coating apparatus 1 of this embodiment, the amount of a coating solution jetted onto the inner peripheral portion 22 of the substrate 2 to be processed by the first coating solution nozzle 18a and the second coating solution nozzle 18b becomes larger than the amount of the coating solution jetted onto the outer peripheral portion 23 thereof by the first and second coating solution nozzles. Thus, the amount of the coating solution shaken off from the substrate 2 to be processed when the coating solution is spread to both the main surfaces 2a and 2b of the substrate 2 to be processed and 2b decreases. For example, as compared to the case where the first coating solution nozzle 18a and the second coating solution nozzle 18b jet the same amount of the coating solution to the inner peripheral portion 22 and outer peripheral portion 23 of the substrate 2 to be processed, the amount of the coating solution to be used in a case where the film thickness of a coating film is the same can be reduced. Additionally, a coating solution which is jetted onto the inner peripheral portion 22, and spread by the rotation of the substrate 2 to be processed, and a coating solution which is jetted onto the outer peripheral portion 23, are supplied to the outer peripheral portion 23 of the substrate 2 to be processed. The coating solution can be sufficiently supplied to the outer peripheral portion 23, the thickness of a coating film of the outer peripheral portion 23 which is apt to become thin as compared with a coating film of the inner peripheral portion 22 can be secured, and the homogeneity of the film thickness at the inner peripheral portion 22 and outer peripheral portion 23 of the substrate 2 to be processed can be improved.

Additionally, the double-side coating apparatus 1 of this embodiment includes a first coating solution nozzle moving mechanism 17a which supports the first coating solution nozzle 18a, and moves the first coating solution nozzle 18a in the diameter direction of the substrate 2 to be processed along one main surface 2a while being separated from one main surface 2a of the substrate 2 to be processed, and a second coating solution nozzle moving mechanism 18b which supports the second coating solution nozzle 18b, and moves the second coating solution nozzle 18b in the diameter direction of the substrate 2 to be processed along the other main surface 2b while being separated from the other main surface 2b of the substrate 2 to be processed. Additionally, when the substrate 2 to be processed is detached, the first coating solution nozzle 18a and the second coating solution nozzle 18b can be moved and retreated by the first coating solution nozzle moving mechanism 17a and the second coating solution nozzle moving mechanism 17b. Accordingly, the first coating solution nozzle 18a and the second coating solution nozzle 18b can easily perform detachment of the substrate 2 to be processed, without deteriorating the workability when the substrate 2 to be processed is detached.

The double-side coating apparatus 1 of this embodiment includes the holding mechanism 3a which holds the substrate 2 to be processed so that the thickness direction of the substrate 2 to be processed becomes the horizontal direction, the rotational driving mechanism 3 which rotates the substrate 2 to be processed in the circumferential direction, the coating solution nozzle composed of the first coating solution nozzle 18a and the second coating solution nozzle 18b which jet a coating solution simultaneously onto both the main surfaces 2a and 2b of the substrate 2 to be processed, and the edge rinsing device 40 which removes the coating solution adhering to both the main surfaces 2a and 2b of the substrate 2 to be processed on which the coating solution is coated, and the outer edge of 2b, the edge rinsing device 40 includes the container 41 which stores a rinsing solution, the liquid level of the rinsing solution is exposed through the top surface of the container 41, and the container 41 is arranged at a position where the outer edge of the substrate 2 to be processed which is rotating is immersed in the rinsing solution. Thus, the edge rinsing can be simultaneously performed on both the main surfaces 2a and 2b of the substrate 2 to be processed after a coating solution is simultaneously coated onto both the main surfaces 2a and 2b of the substrate 2 to be processed, and the time taken until the edge rinsing is performed after the coating solution is coated becomes constant in both the main surfaces 2a and 2b of the substrate 2 to be processed.

Additionally, since the double-side coating apparatus 1 of this embodiment can perform coating and edge rinsing on both the main surfaces 2a and 2b of the substrate 2 to be processed, it is possible to make small the space for performing coating and edge rinsing.

Additionally, in the double-side coating apparatus 1 of this embodiment, since the edge rinsing is simultaneously performed on both the main surfaces 2a and 2b of the substrate 2 to be processed after a coating solution is simultaneously coated onto both the main surfaces 2a and 2b of the substrate 2 to be processed, coating and edge rinsing can be efficiently performed in a short time.

Additionally, in the double-side coating apparatus 1 of this embodiment, the coating solution nozzle is composed of the first coating solution nozzle 18a which jets a coating solution onto one main surface 2a of the substrate 2 to be processed, and the second coating solution nozzle 18b which jets the coating solution onto the other main surface 2b of the substrate 2 to be processed, and the first coating solution nozzle 18a and the second coating solution nozzle 18b are symmetrically arranged with respect to the thickness center plane of the substrate 2 to be processed. Thus, a coating solution is simultaneously supplied to the same position in both the main surfaces 2a and 2b of the substrate 2 to be processed, by jetting the coating solution simultaneously toward the substrate 2 to be processed from the first coating solution nozzle 18a and the second coating solution nozzle 18b. Therefore, according to the double-side coating apparatus 1 of this embodiment, as there is no difference resulting from gravity in coating onto one main surface 2a of the substrate 2 to be processed, and coating onto the other main surface 2b, or difference resulting from coating positions, the coating solution can be uniformly coated onto both the surfaces of the substrate 2 to be processed, and uniform coating films can be formed on both the surfaces of the substrate 2 to be processed. As a result, the difference between coating films in both the main surfaces 2a and 2b of the substrate 2 to be processed decreases, and in a case where the outer edges of both the main surfaces 2a and 2b of the substrate 2 to be processed are simultaneously edge-rinsed on the same conditions, the difference in edge rinse effect between both the main surfaces 2a and 2b decreases. Optimization of the conditions when the edge rinsing is performed becomes easy, and the edge rinsing can be surely efficiently and easily performed on the optimal conditions.

Additionally, in the double-side coating apparatus 1 of this embodiment, the suction part 43a which sucks droplets consisting of a rinsing solution is arranged adjacent to the edge rinsing device 40. Thus, the suction part 43a can be made to suck fine misty droplets consisting of a rinsing solution, which are generated during the edge rinsing of the substrate 2 to be processed, and the suction part 43a can be made to suck gas within the apparatus when being edge-rinsed. Accordingly, a failure which occurs as fine misty droplets consisting of a rinsing solution adhere to the substrate 2 to be processed can be reduced, and edge rinsing can be performed in a stable gas atmosphere in which the flow of gas to the substrate 2 to be processed when being edge-rinsed is controlled.

Additionally, in the double-side coating apparatus of this embodiment, the suction part 43a is arranged at a position, on the side of the rotational direction of the substrate 2 to be processed, in the container 41 in which fine misty droplets consisting of a rinsing solution are apt to be scattered is during the edge rinsing of the substrate 2 to be processed. Thus, the suction part 43a can be made to more efficiently suck droplets consisting of a rinsing solution generated when being edge-rinsed.

The double-side coating apparatus 1 of this embodiment includes the holding mechanism 3a which holds the substrate 2 to be processed so that the thickness direction of the substrate 2 to be processed becomes the horizontal direction, the rotational driving mechanism 3 which rotates the substrate 2 to be processed in the circumferential direction, the first coating solution nozzle 18a and the second coating solution nozzle 18b which jet a coating solution to both the main surfaces 2a and 2b of the substrate 2 to be processed, and the first head rinsing solution nozzle 19a and the second head rinsing solution nozzle 19b which jets a rinsing solution to clean the first coating solution nozzle 18a, and the second coating solution nozzle 18b. Thus, after the coating solution is jetted toward the substrate 2 to be processed from the first coating solution nozzle 18a and the second coating solution nozzle 18b, a rinsing solution can be jetted from the first head rinsing solution nozzle 19a and the second head rinsing solution nozzle 19b, thereby cleaning the first coating solution nozzle 18a and the second coating solution nozzle 18b. Accordingly, the first coating solution nozzle 18a and the second coating solution nozzle 18b can be prevented from being clogged, variation in the amount of jetting, which is caused when a coating solution or a coating film adheres to the first coating solution nozzle 18a and the second coating solution nozzle 18b, can be prevented, and even in a case where coating is performed on a plurality of substrates 2 to be processed, there is little variation in the amount of coating, and the amount of coating can be controlled with high precision.

Additionally, in the double-side coating apparatus 1 of this embodiment, the coating solution nozzle is composed of the first coating solution nozzle 18a which jets a coating solution onto one main surface 2a of the substrate 2 to be processed, and the second coating solution nozzle 18b which jets the coating solution onto the other main surface 2b of the substrate 2 to be processed, the first coating solution nozzle 18a and the second coating solution nozzle 18b are symmetrically arranged with respect to the thickness center plane of the substrate 2 to be processed, and the head rinsing nozzle is composed of the first head rinsing solution nozzle 19a which is provided adjacent to the first coating solution nozzle 18a above the first coating solution nozzle 18a, and the second head rinsing solution nozzle 19b which is provided adjacent to the second coating solution nozzle 18b above the second coating solution nozzle 18b. The cleaning of the first coating solution nozzle 18a and the second coating solution nozzle 18b can be performed by jetting a rinsing solution from a head rinsing solution nozzle on the facing side, by jetting a rinsing solution downward from a head rinsing solution nozzle on the same side, or by performing both rinsing method. That is, the cleaning can be performed by selecting a proper optimal method.

Additionally, the double-side coating apparatus 1 of this embodiment includes a first coating solution nozzle moving mechanism 17a which supports the first coating solution nozzle 18a and the first head rinsing solution nozzle 19a, and moves the first coating solution nozzle 18a in the diameter direction of the substrate 2 to be processed along one main surface 2a while being separated from one main surface 2a of the substrate 2 to be processed, and a second coating solution nozzle moving mechanism 17b which supports the second coating solution nozzle 18b and the second head rinsing solution nozzle 19b, and moves the second coating solution nozzle 18b in the diameter direction of the substrate 2 to be processed along the other main surface 2b while being separated from the other main surface 2b of the substrate 2 to be processed. Thus, the first coating solution nozzle 18a and the second coating solution nozzle 18b and the first and second head rinsing solution nozzles 19a and 19b can be retreated into the head rinsing portion 6b or the like provided in the substrate-to-be processed housing portion 6 by the first coating solution nozzle moving mechanism 17a and the second coating solution nozzle moving mechanism 17b, thereby performing the cleaning of the first coating solution nozzle 18a and the second coating solution nozzle 18b. Hence, the waste liquid generated by the cleaning of the first coating solution nozzle 18a and the second coating solution nozzle 18b can be prevented from being scattered into the main body 6a of the substrate-to-be processed housing portion 6.

Additionally, the double-side coating apparatus 1 of this embodiment includes the coating solution supply device 20 which supplies a coating solution to the first coating solution nozzle 18a and the second coating solution nozzle 18b, and the rinsing solution supply device 21 which supplies a rinsing solution to the first head rinsing solution nozzle 19a and the second head rinsing solution nozzle 19b, the coating solution supply device 20 is provided with the coating solution piping 20b which connects the first coating solution nozzle 18a and the second coating solution nozzle 18b with the coating solution tank 20a, the rinsing solution supply device 21 is provided with the rinsing solution piping 21b which connects the first head rinsing solution nozzle 19a and the second head rinsing solution nozzle 19b with the rinsing solution tank 21a, the rinsing solution piping 21b is connected to the coating solution piping 20b by the connection piping 28a, and the switching valve 28 is connected to the connection piping 28a. The switching valve 28 can be switched to perform the ling cleaning of cleaning the coating solution piping 20b nearer to the first and second coating solution nozzles 18a and 18b than the switching valve 28, and the first and second coating solution nozzles 18a and 18b, and variation in the amount of jetting, which is caused when a coating solution or a coating film adheres to the coating solution piping 20b nearer to the first and second coating solution nozzles 18a and 18b than the switching valve 28, and the first and second coating solution nozzles 18a and 18b, can be prevented.

Additionally, since the double-side coating method of this embodiment includes a coating solution nozzle cleaning step of jetting a rinsing solution from the first head rinsing solution nozzle 19a, and the second head rinsing solution nozzle 19b, thereby cleaning the first coating solution nozzle 18a and the second coating solution nozzle 18b. Thus, the first coating solution nozzle 18a and the second coating solution nozzle 18b can be prevented from being clogged, variation in the amount of jetting, which is caused when a coating solution or a coating film adheres to the first coating solution nozzle 18a and the second coating solution nozzle 18b, can be prevented, and even in a case where coating is performed on a plurality of substrates 2 to be processed, there is little variation in the amount of coating, and the amount of coating can be controlled with high precision.

<Edge Rinsing Apparatus (Double-Side Coating Apparatus)>

Next, as an example of the edge rinsing apparatus of the invention, one embodiment of a double-side coating apparatus (edge rinsing apparatus) which coats a coating solution on both main surfaces of a substrate to be processed, and performs edge rinsing of the substrate to be processed on both the surfaces of which a collating liquid has been coated, and an edge rinsing method using this will be described.

FIG. 2 is a schematic diagram for explaining the overall configuration of the double-side coating apparatus of this embodiment, and is a front view seen from one main surface of a substrate to be processed. Additionally, FIG. 3 is a longitudinal sectional view showing a portion of the double-side coating apparatus shown in FIG. 2, and FIG. 4 is a top view showing a portion of the double-side coating apparatus shown in FIG. 2.

The double-side coating apparatus 1 shown in FIGS. 2 to 4 supplies a coating solution to one main surface 2a and other main surface 2b of a doughnut disk-shaped substrate 2 to be processed, rotationally operates the substrate 2 to be processed to spread the coating solution on one main surface 2a and other main surface 2b, thereby forming coating films on the one main surface 2a and other main surface 2b of the substrate 2 to be processed, and performs edge rinsing of the substrate 2 to be processed on both the main surfaces 2a and 2b of which the coating solution has been coated.

The other portions of this embodiment are the same as the description about the embodiment of the double-side coating apparatus.

<Manufacture of Discrete Magnetic Recording Medium>

Next, a case where a coating and edge rinsing method using the double-side coating apparatus 1 shown in FIG. 2 is applied to a resist layer forming step in a method of manufacturing the discrete magnetic recording medium shown in FIG. 1 will be described.

FIGS. 6 to 8 are process drawings for explaining the process of manufacturing the discrete magnetic recording medium shown in FIG. 1. Additionally, FIG. 9 is a view for explaining the operation of the double-side coating apparatus 1 shown in FIG. 2, and is a front view seen from one main surface 2a of the substrate 2 to be processed.

The detailed description about an example of the case where the edge rinsing apparatus (double-side coating apparatus) of this embodiment and the edge rinsing method using this are applied to a resist layer forming step is the same as the description of the embodiment of the above double-side coating apparatus.

However, the method of manufacturing a discrete magnetic recording medium is not limited to the above-described method. For example, the following methods may be used.

That is, a protective layer may be formed on a magnetic layer, a resist pattern made to match a magnetic recording pattern may be formed on the surface of the protective layer, using the double-side coating apparatus of the invention, and then reforming treatment of the magnetic layer by the reactive plasma may be performed. In such a method, it is not necessary to form a protective film after the reactive plasma treatment, and the effects of improvement in productivity and reduction in contamination in the process of manufacturing a magnetic recording medium are obtained. In addition, the present inventors confirmed that it is possible to cause the reaction between the magnetic layer and the reactive plasma after the protective film is formed on the surface of the magnetic layer.

The double-side coating apparatus (edge rinsing apparatus) of this embodiment includes the holding mechanism 3a which holds the substrate 2 to be processed so that the thickness direction of the substrate 2 to be processed becomes the horizontal direction, the rotational driving mechanism 3 which rotates the substrate 2 to be processed in the circumferential direction, and the container 41 which stores a rinsing solution, the liquid level of the rinsing solution is exposed through the top surface of the container 41, and the container 41 is arranged at a position where the outer edge of the substrate 2 to be processed which is being rotated is immersed in the rinsing solution. By setting the width of the outer edge of the substrate 2 to be processed, which is immersed in the rinsing solution, to a predetermined width, only a region with a fixed width, of the outer edge of the substrate 2 to be processed can be accurately and stably rinsed, and the width of the outer edge to be rinsed can be easily controlled. Accordingly, even if the width of the outer edge to be rinsed is small, there is little chance of the width of the outer edge to be rinsed becoming uneven, or a coating film remaining on the outer edge of the substrate, and the yield can be improved.

Additionally, according to the double-side coating apparatus 1 of this embodiment, the edge rinsing can be simultaneously performed on both the main surfaces 2a and 2b of the substrate 2 to be processed. Thus, the coating and the edge rinsing can be easily performed in a short time on both the main surfaces 2a and 2b of the substrate 2 to be processed.

Additionally, the double-side coating apparatus of this embodiment is provided with the container moving mechanism 42 which supports the container 41 and moves the container 41 in the horizontal direction and in the vertical direction. Thus, the container 41 can be retreated when the substrate 2 to be processed is detached. Accordingly, the container 41 can easily perform detachment of the substrate 2 to be processed, without deteriorating the workability when the substrate 2 to be processed is detached.

Additionally, in the double-side coating apparatus of this embodiment, the suction part 43a which sucks droplets consisting of a rinsing solution is arranged adjacent to the container 41. Thus, the suction part 43a can be made to suck fine misty droplets consisting of a rinsing solution, which are generated during the edge rinsing of the substrate 2 to be processed, and the suction part 43a can be made to suck gas within the apparatus when being edge-rinsed.

Accordingly, defects generated as fine misty droplets consisting of a rinsing solution adhering to the substrate 2 to be processed can be reduced, and edge rinsing can be performed in a stable gas atmosphere in which the flow of gas to the substrate 2 to be processed when being edge-rinsed is controlled.

Additionally, in the double-side coating apparatus of this embodiment, the suction part 43a is arranged at a position, on the side of the rotational direction of the substrate 2 to be processed, in the container 41 in which fine misty droplets consisting of a rinsing solution are apt to be scattered during the edge rinsing of the substrate 2 to be processed. Thus, the suction part 43a can be made to more efficiently suck droplets consisting of a rinsing solution generated when being edge-rinsed.

Additionally, in the double-side coating apparatus of this embodiment, the suction part moving mechanism 44 is provided to support the suction part 43a and move the suction part 43a in the horizontal direction and in the vertical direction. Additionally, when the substrate 2 to be processed is detached, the suction part 43a can be retreated to the outside of the substrate-to-be processed housing portion 6. Accordingly, the suction part 43a can easily perform detachment of the substrate 2 to be processed, without deteriorating the workability when the substrate 2 to be processed is detached.

Next, although the edge rinsing apparatus of the invention will be described in more details by showing examples and a comparative example, the invention is not limited only to these examples.

### Examples 1 to 4

The double-side coating apparatus (edge rinsing apparatus) 1 shown in FIG. 2 was used to form a resist coating film with a film thickness of 100 nm made of an ultraviolet-curable acrylic ester resin, on both the main surfaces 2a and 2b of the substrate 2 to be processed, and to perform edge rinsing of the substrate 2 to be processed on both the main surfaces 2a and 2b of which a coating solution has been coated onto the conditions shown below.

Rinsing solution: acetone

Suction power of suction part 43a: 0.5 m³/min

Time taken until edge rinsing is started after jetting of coating solution is ended: 10 seconds

Time taken until edge rinsing is ended after being started: 10 seconds

In addition, the rotation number of a substrate to be processed during edge rinsing, and the amount (the width of the outer edge immersed in the rinsing solution) of immersion of the substrate into a rinsing solution, which are different conditions in the respective Examples 1 to 4, are shown in Table 1.

TABLE 1

| | | Amount of | |
|---|---|---|---|
| | | immersion of | |
| | | substrate into rinsing | |
| | | solution in Examples, | Poor rinsing at |
| | | and width of jetting of | outer peripheral |
| | | rinsing solution from | portion |
| | | outer periphery of | (Number of |
| | | substrate by nozzle in | remaining resin |
| | Rotation Number | Comparative Examples | portion) |
| | (rpm) | (mm) | (portions) |
| Example 1 | 500 | 0.2 | 0 |
| Example 2 | 1000 | 0.1 | 0 |
| Example 3 | 2000 | 0.1 | 0 |
| Example 4 | 3000 | 0.1 | 0 |
| Comparative | 500 | 1.4 | 10 |
| Example 1 | | | |
| Comparative | 1000 | 1.5 | 7 |
| Example 2 | | | |
| Comparative | 2000 | 1.7 | 9 |
| Example 3 | | | |
| Comparative | 3000 | 1.2 | 10 |
| Example 4 | | | |

### Comparative Examples 1 to 4

The same resist coating films as Examples 1 to 4 were formed similarly to Examples 1 to 4, and edge rinsing of the substrate 2 to be processed was performed by jetting a rinsing solution to the peripheral edge of one main surface 2a of the substrate 2 to be processed using a first nozzle, and jetting the rinsing solution to the peripheral edge of the other main surface 2b of the substrate 2 to be processed using a second nozzle.

In addition, in Comparative Examples 1 to 4, the rinsing solution, the time taken until the edge rinsing is started after jetting of the coating solution is ended, and the time taken until the edge rinsing is ended after being started were made the same as Examples 1 to 4.

Additionally, the rotation number of a substrate to be processed during edge rinsing, and the width of jetting of the rinsing solution jetted from the first and second nozzles from the outer periphery of the substrate 2 to be processed, which are different conditions in the respective Examples 1 to 4, are shown in Table 1.

Additionally, the number of failures (residual resin portion) of rinsing at the peripheral edges of the resist coating films of Examples 1 to 4 and Comparative Examples 1 to 4, which are formed as described above, is shown in Table 1.

As shown in Table 1, there was no residual resin in Examples 1 to 4. On the other hand, in Comparative Examples 1 to 4, seven to ten residual resin portions were confirmed.

Additionally, as shown in Table 1, in Examples 1 to 4, it can be seen that the amount of immersion into the rinsing solution can be made as small as 0.2 mm or less, and only a region to be rinsed can be rinsed even if the width of the outer edge to be rinsed is small.

On the other hand, in Comparative Examples 1 to 4, it can be seen that the control of the width of the outer edge to be rinsed is difficult in a case where the width of jetting of the rinsing solution jetted from the first and second nozzles from the outer periphery of the substrate 2 to be processed is larger compared to the amount of immersion into the rinsing solution in Examples 1 to 4, and the width of the outer edge to rinse is small.

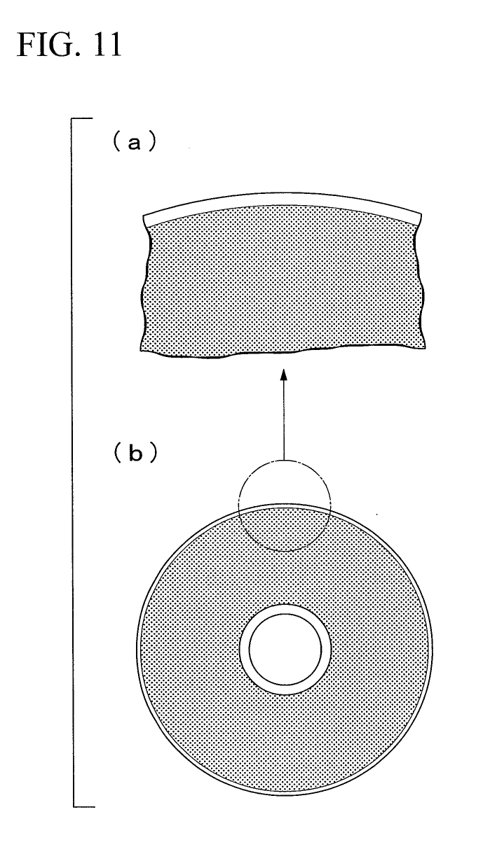

Additionally, the resist coating film formed in Example 1 is shown in FIGS. 11A and 11B. FIGS. 11A and 11B are plan views of the resist coating film, and FIG. 11A is a partially enlarged view showing a portion of FIG. 11B.

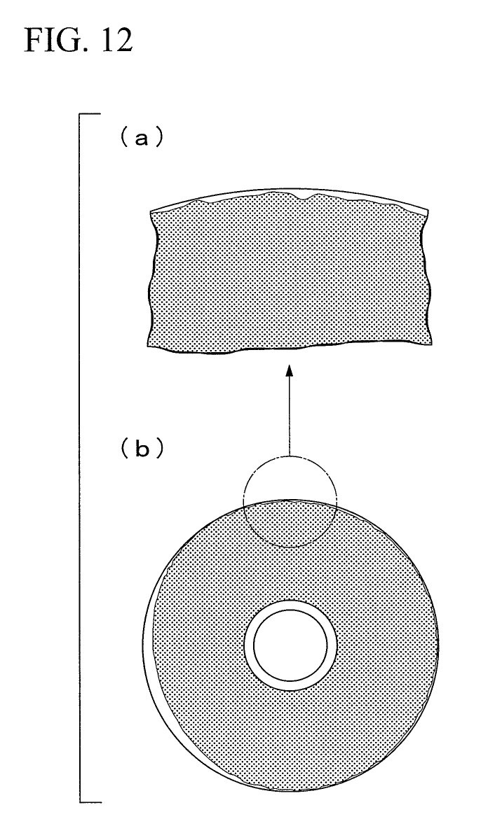

Additionally, the resist coating film formed in Comparative Example 1 is shown in FIGS. 12A and 12B. FIGS. 12A and 12B are plan views of the resist coating film, and FIG. 12A is a partially enlarged view showing a portion of FIG. 12B.

The resist coating film which is an example of the invention, as shown in FIG. 11B, is uniform with no unevenness in the width of the rinsed outer edge, and as shown in FIG. 11A, the edge of the resist coating film is smooth.

On the other hand, the resist coating film which is a comparative example, as shown in FIG. 12B, has large unevenness in the width of the rinsed outer edge, and as shown in FIG. 12A, the edge of the resist coating film is jagged.

### INDUSTRIAL APPLICABILITY

Applications of the invention include a double-side coating apparatus which coats a coating solution for forming resist layers on magnetic layers provided in both surfaces of a disk substrate having a central opening.

1.-18. (canceled)

19. A method for coating double sides with a coating solution which supplies a coating solution to both main surfaces of a substrate to be processed, and rotationally operates the substrate to be processed to spread the coating solution on both the main surfaces, thereby forming coating films on both the main surfaces of the substrate to be processed,
wherein the method holds the substrate to be processed so that the thickness direction of the substrate to be processed is a horizontal direction, rotates the substrate to be processed in a circumferential direction, and simultaneously jets the coating solution toward the substrate to be processed from a first coating solution nozzle which jets the coating solution onto one main surface of the substrate to be processed, and a second coating solution nozzle which is symmetrically arranged with respect to the first coating solution nozzle and a thickness center plane of the substrate to be processed, and jets the coating solution onto the other main surface of the substrate to be processed.

20. The method for coating double sides with a coating solution according to claim 19,
wherein the coating solution is jetted onto the inner peripheral portion and outer peripheral portion of the substrate to be processed from the first coating solution nozzle and the second coating solution nozzle.

21. The method for coating double sides with a coating solution according to claim 19,
wherein the amount of the coating solution jetted onto the inner peripheral portion from the first coating solution nozzle and the second coating solution nozzle is made larger than the amount of the coating solution jetted onto the outer peripheral portion of the substrate to be processed from the first and second coating solution nozzles.

22. The method for coating double sides with a coating solution according to claim 19, further comprising an edge rinsing step of arranging a container, which stores a rinsing solution and has the liquid level of the rinsing solution exposed through the top surface thereof, at a position where the outer edge of the substrate to be processed which is being rotated after the coating step is immersed in the rinsing solution.

23. The method for coating double sides with a coating solution according to claim 22,
wherein the edge rinsing step is performed while droplets consisting of the rinsing solution are sucked by a suction part which is arranged adjacent to the container.

24. The method for coating double sides with a coating solution according to claim 19, further comprising a coating solution nozzle cleaning step of jetting a rinsing solution from the head rinsing nozzle to clean the coating solution nozzle.

25. (canceled)

26. An edge rinsing method which removes a coating solution adhering to outer edges of both main surfaces of a substrate to be processed on which the coating solution has been coated, the edge rinsing method comprising:
an edge rinsing step of holding the substrate to be processed so that the thickness direction of the substrate to be processed is a horizontal direction, thereby rotating the substrate to be processed in a circumferential direction, and arranging a container which stores a rinsing solution, and has the liquid level of the rinsing solution exposed through the top surface of the container, at a position where the outer edges of the substrate to be processed which is rotating are immersed in the rinsing solution.

27. The edge rinsing method according to claim 26, further comprising an attaching/detaching step which attaches and detaches the substrate to be processed to/from a holding mechanism which holds the substrate to be processed, and the attaching/detaching step is performed by moving the container in a horizontal direction and in a vertical direction by a container moving mechanism which supports the container, thereby retreating the container.

28. The edge rinsing method according to claim 26,
wherein the edge rinsing step is performed while droplets consisting of the rinsing solution are sucked by a suction part which is arranged adjacent to the container.
